(19) United States
(12) Patent Application Publication
(10) Pub. No.: US 2006/0204782 A1
(43) Pub. Date: Sep. 14, 2006

(54) Polymer and polymer light-emitting device using same

(75) Inventors: Akihiko Okada, Tsukuba-shi (JP); Tomoyuki Suziki, Tsukuba-shi (JP); Hideaki Nakajima, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 10/550,209

(22) PCT Filed: Mar. 29, 2004
(86) PCT No.: PCT/JP04/04431

§ 371 Date: Sep. 21, 2005

(30) Foreign Application Priority Data
Mar. 31, 2003 (JP) 2003-094088

(51) Int. Cl. B32B 19/00

(52) U.S. Cl. 428/690

(57) ABSTRACT

A polymer emitting fluorescence in the solid state, having a polystyrene-reduced weight-average molecular weight of 10³ to 10⁸ and having a repeating unit selected from the group consisting of arylene group, divalent heterocyclic group and divalent aromatic amine group, wherein the polymer has an unsaturated hydrocarbon group free of aromatic ring which directly bonds to any one of the repeating units, at least, at one terminal end of the main chain thereof.

### TECHNICAL FIELD

The invention relates to a polymer and a polymer light emitting device using the same (hereafter, referred to as a polymer LED).

### BACKGROUND ART

Since light emitting substances having high molecular weight are different from those having low molecular weight in terms of being soluble in solvents and being able to form a light emitting layer for light emitting device by coating methods, various types of them have been studied; known as one of examples is a polymer whose main chain has a repeating unit containing aromatic ring and a phenyl group at the terminal end thereof (WO01/49769).

Where, for example, a polymer is used as a light emitting substance for a light emitting device, the polymer has to be resistible to electrolytic oxidation and/or reduction, particularly to electrolytic reduction which seems to be frequently caused by the electric current supplied to a light emitting device.

The above polymer, however, has disadvantage of insufficient resistibility to electrolytic reduction.

### DISCLOSURE OF THE INVENTION

The object of the invention is to provide a polymer which is resistible to electrolytic oxidation and/or reduction, particularly to electrolytic reduction.

The inventors of the invention have diligently studied to solve the above problems, found that a polymer having a terminal end group of unsaturated hydrocarbon group free of aromatic ring at least at one terminal end thereof is resistible to electrolytic reduction, and achieved the invention.

Namely, the invention provides a polymer emitting fluorescence in the solid state, having a polystyrene-reduced weight-average molecular weight of 10³ to 10⁸ and having a repeating unit selected from the group consisting of arylene group, divalent heterocyclic group and divalent aromatic amine group, wherein the polymer has an unsaturated hydrocarbon group free of aromatic ring at least at one terminal end of the main chain thereof with being directly coupled with any of the repeating units. The term of “emitting fluorescence” defines that a compound emits light through excited “singlet” state when the compound is excited by absorption of excitation energy such as light or electric energy.

### BEST MODE FOR CARRYING OUT THE INVENTION

The polymer of the invention has an unsaturated hydrocarbon group free of aromatic ring at least at one terminal end of the main chain thereof with being directly coupled with any of the repeating units thereof. To say another word, the polymer of the invention has at terminal ends thereof a structure represented by the following formula (1):
-A-E (1)
wherein A represents any of the repeating units included in the polymer and E represents an unsaturated hydrocarbon group free of aromatic ring.

The number of carbon atoms of the unsaturated hydrocarbon group free of aromatic ring which is included in the polymer of the invention, is usually about 3 to 20, and preferably 4 to 12. The term of unsaturated bond defines a double bond or a triple bond.

The unsaturated hydrocarbon group free of aromatic ring includes, for example, an acyclic hydrocarbon group containing unsaturated bond and being optionally substituted by alicyclic hydrocarbon group; and an alicyclic hydrocarbon group containing unsaturated bond and being optionally substituted by acyclic hydrocarbon group.

As the unsaturated hydrocarbon group free of aromatic ring, following groups are exemplified.

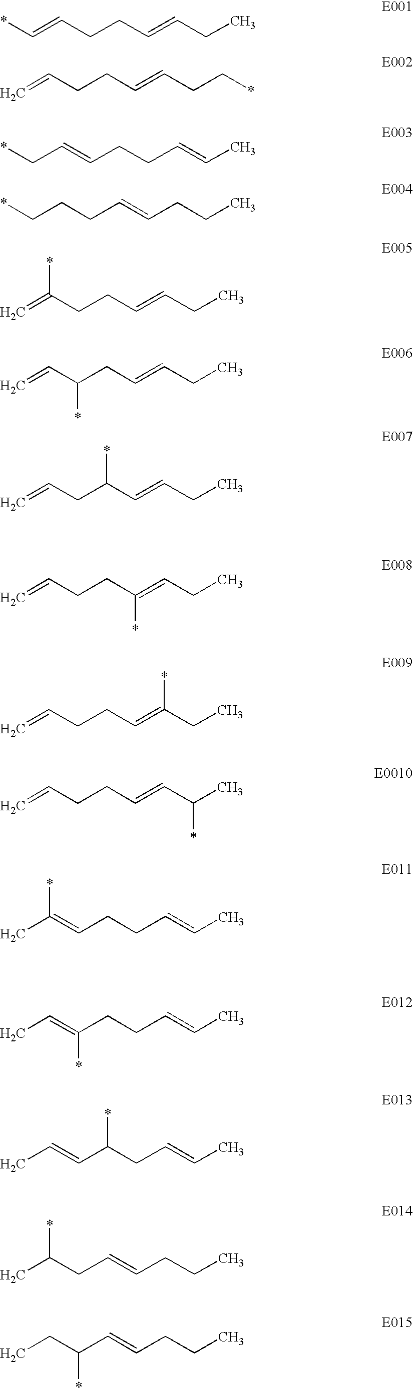

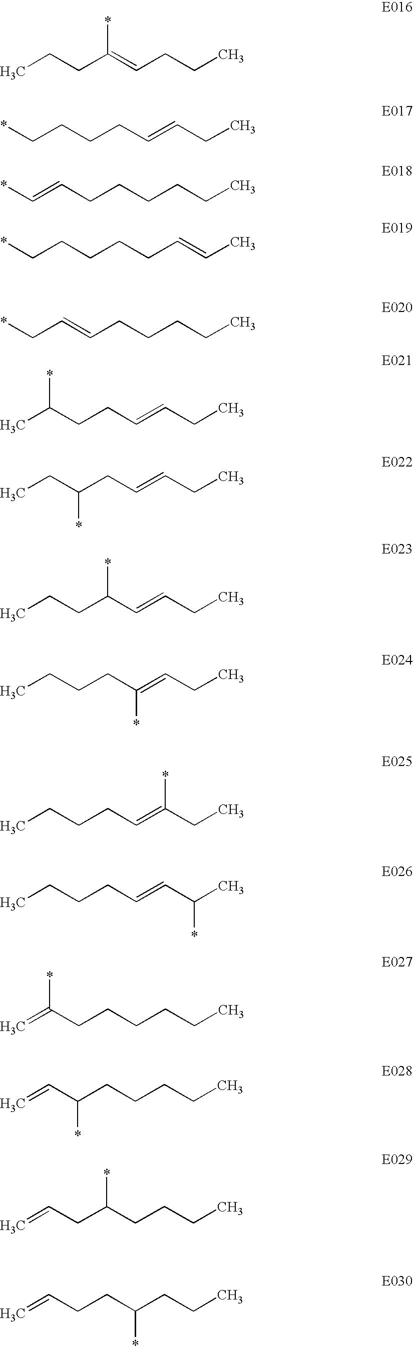

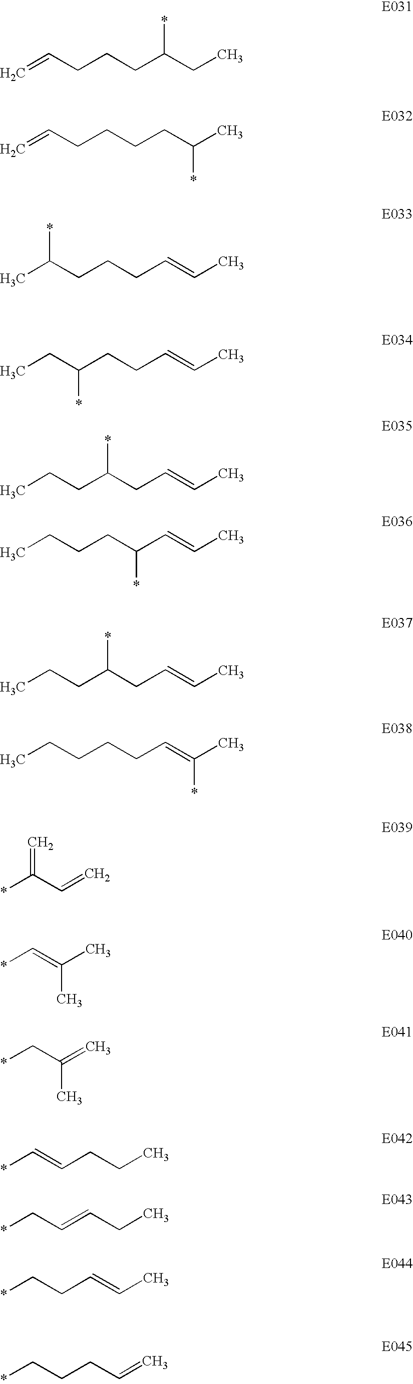

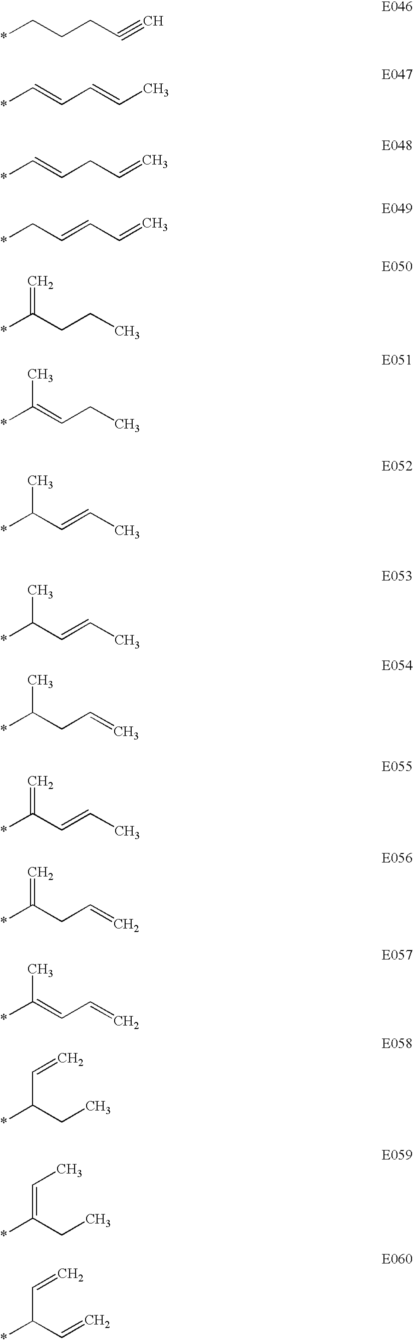

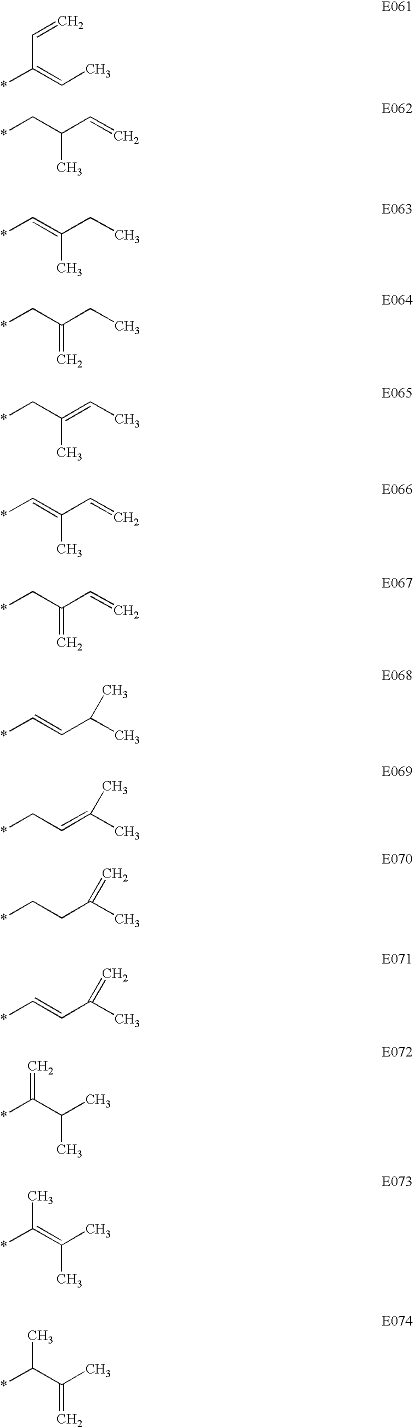

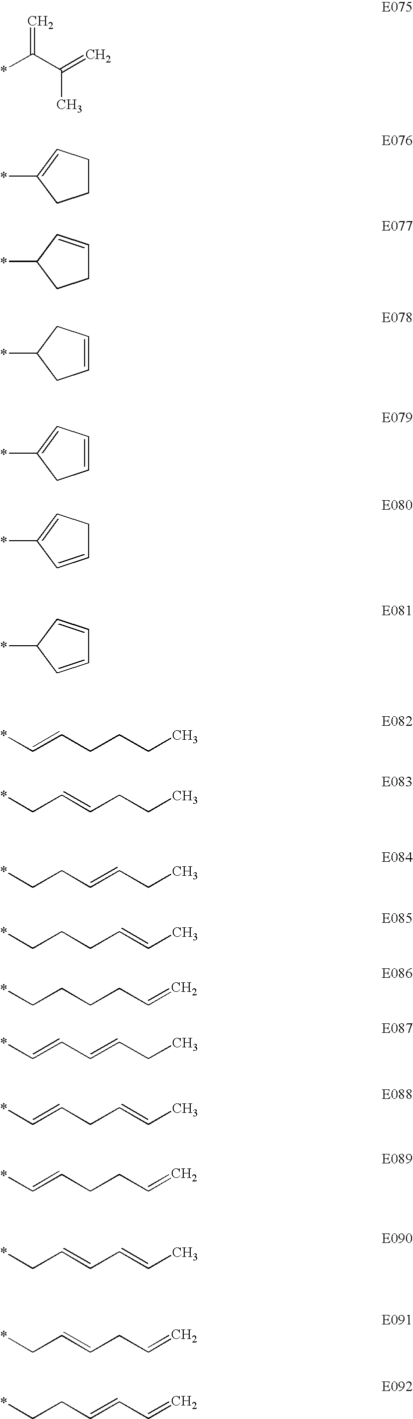

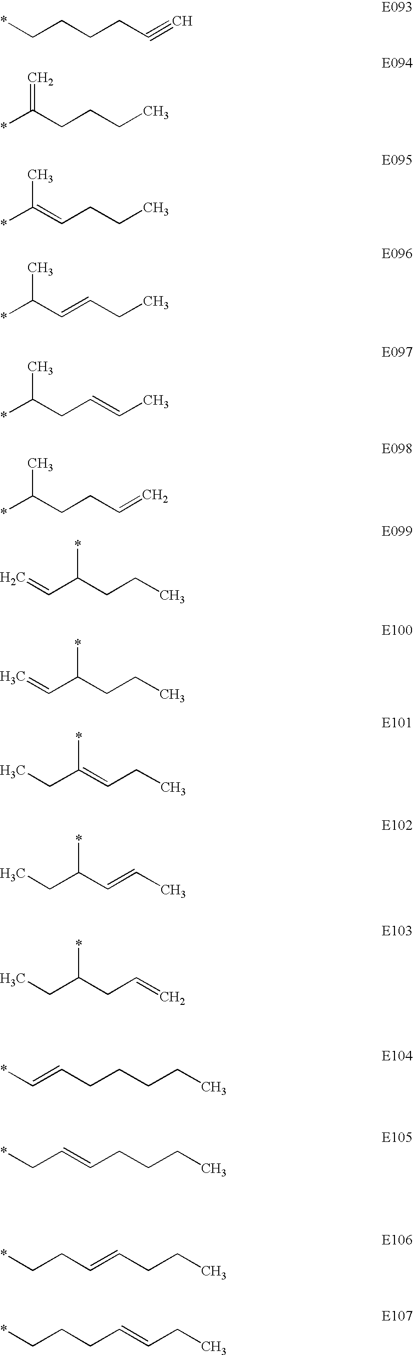

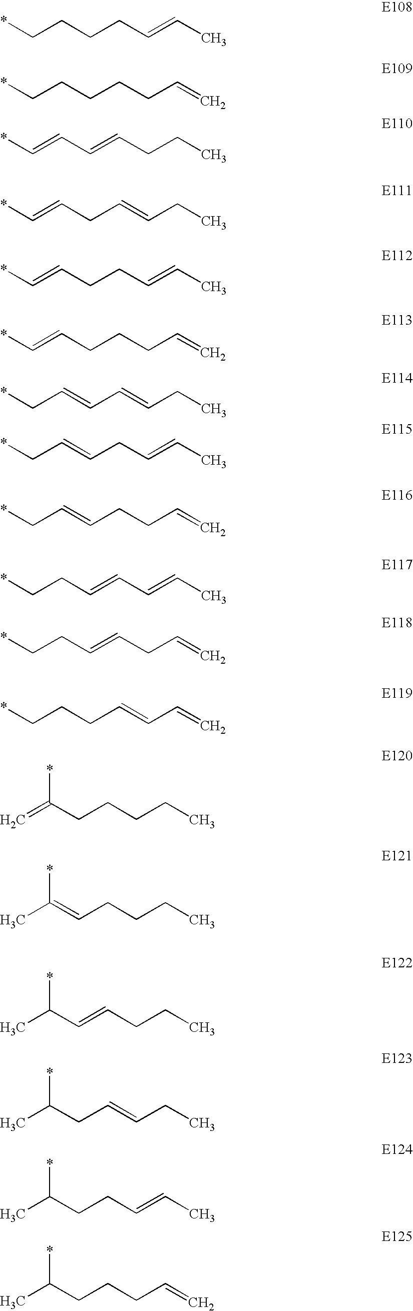

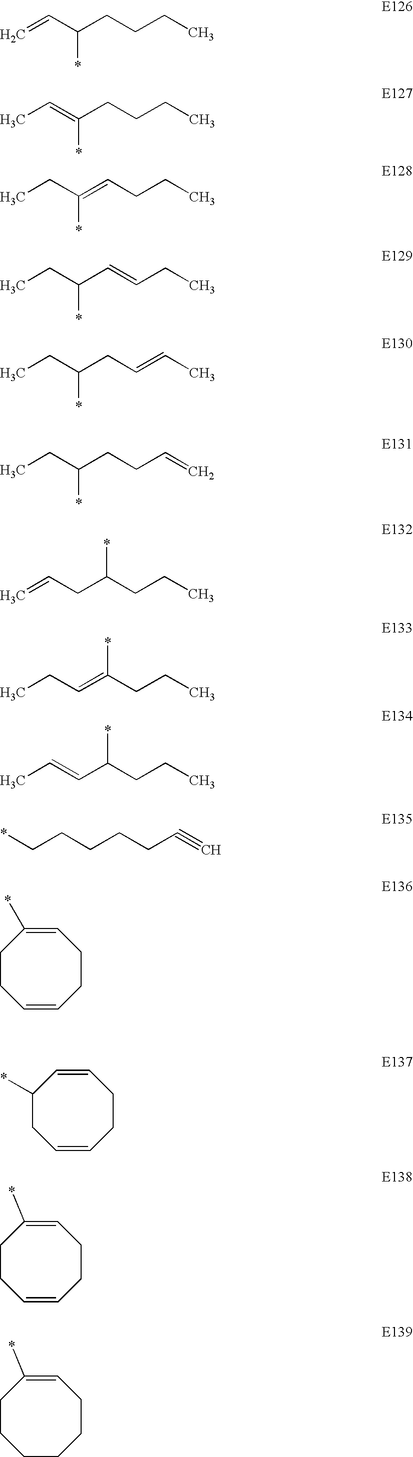

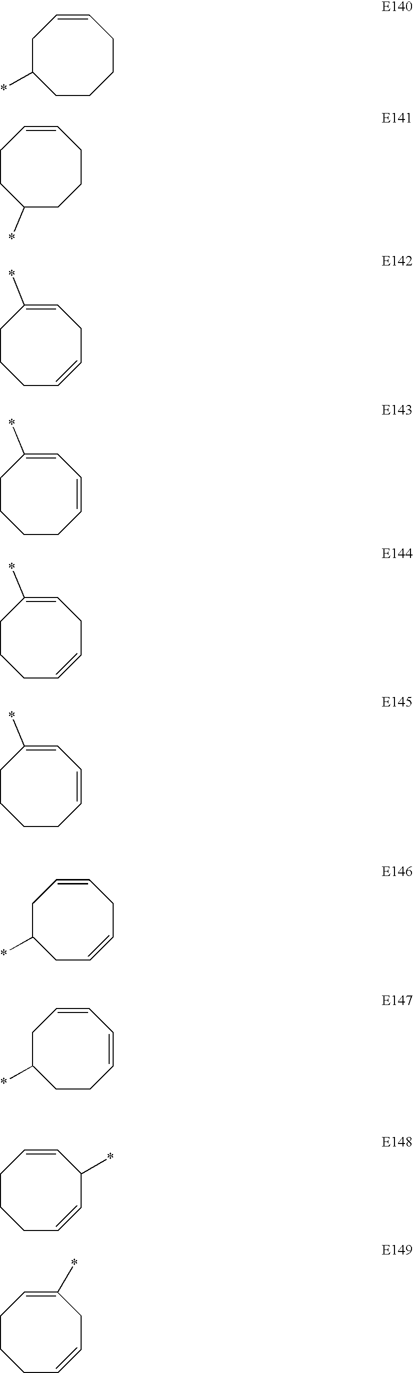

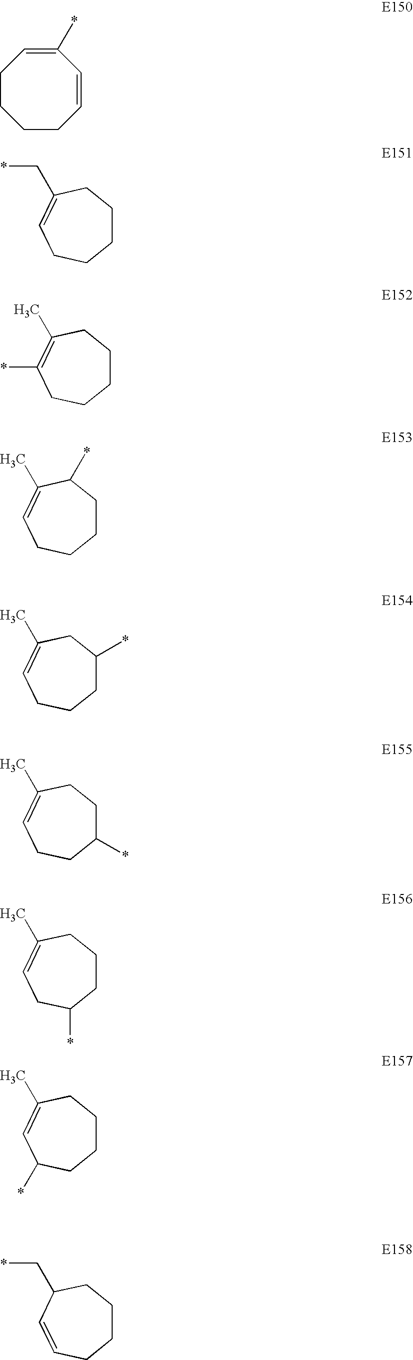

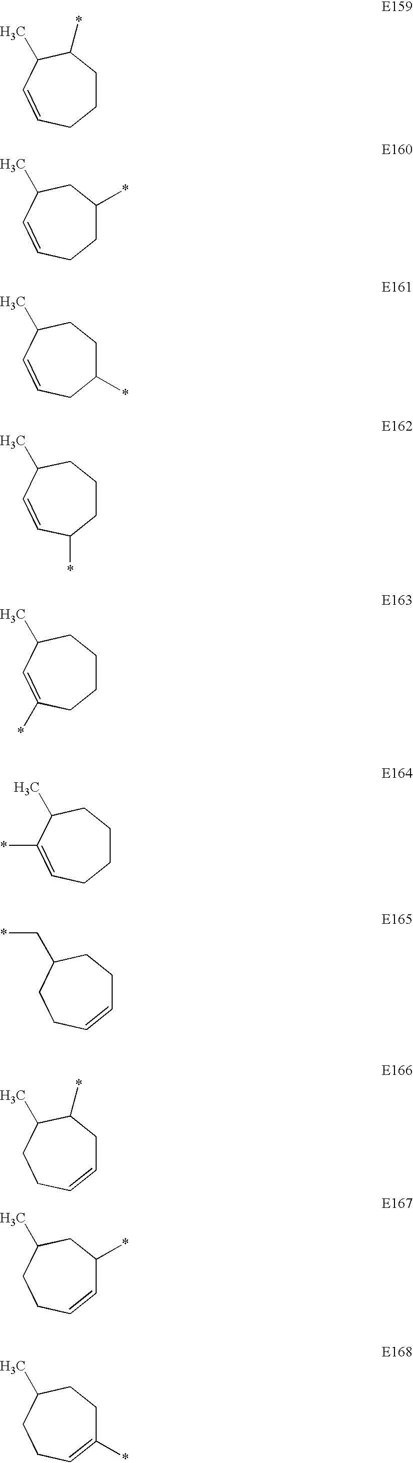

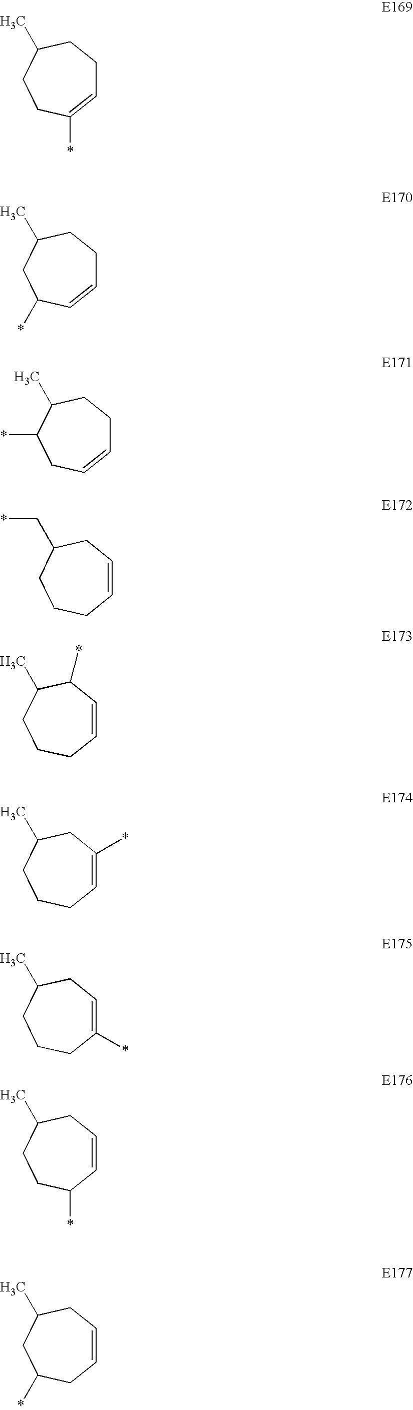

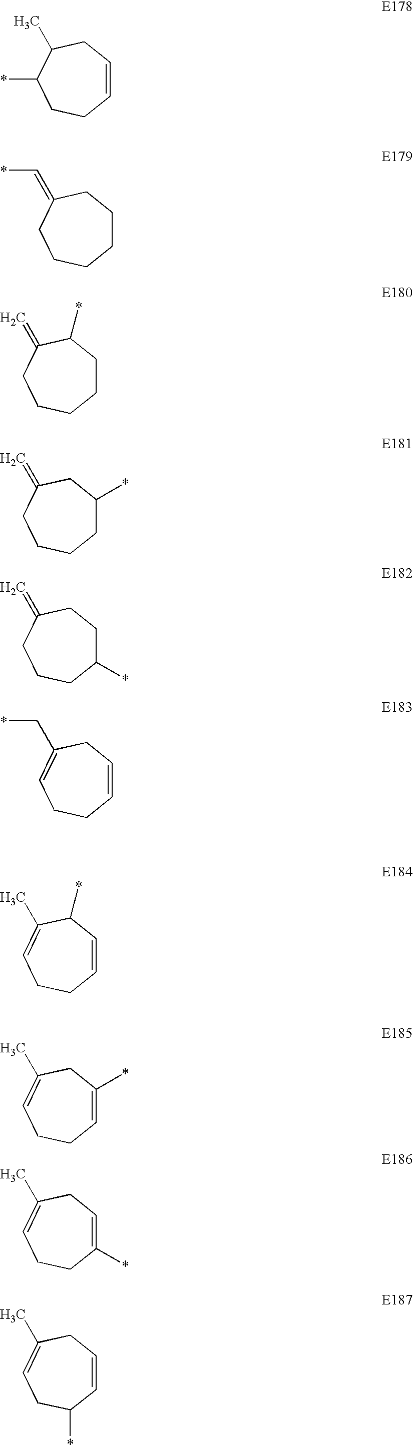

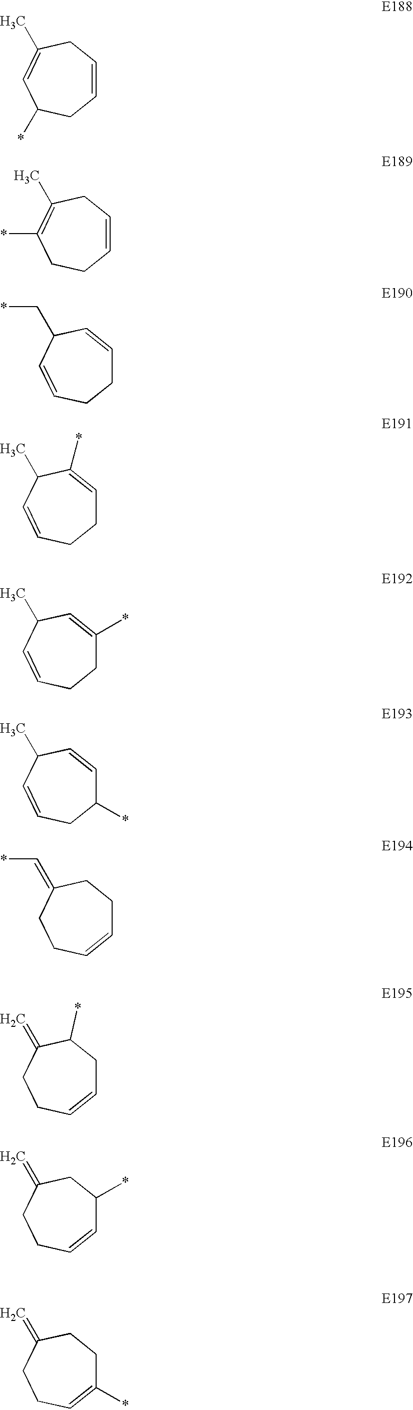

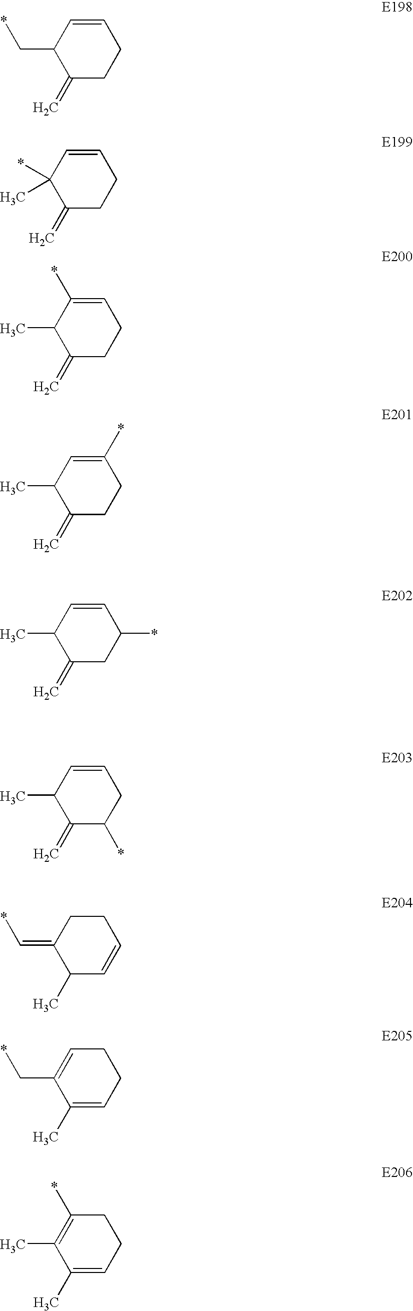

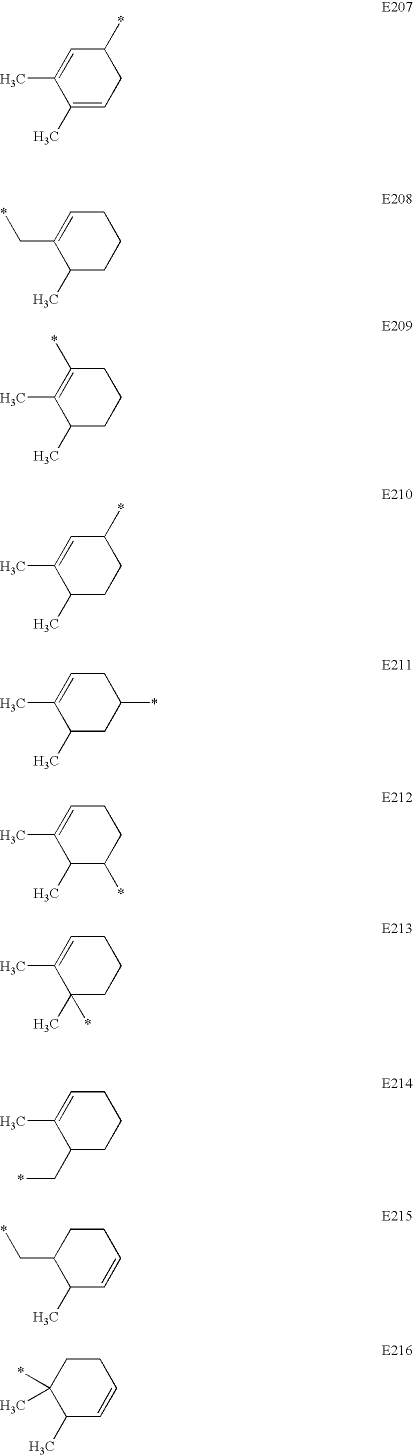

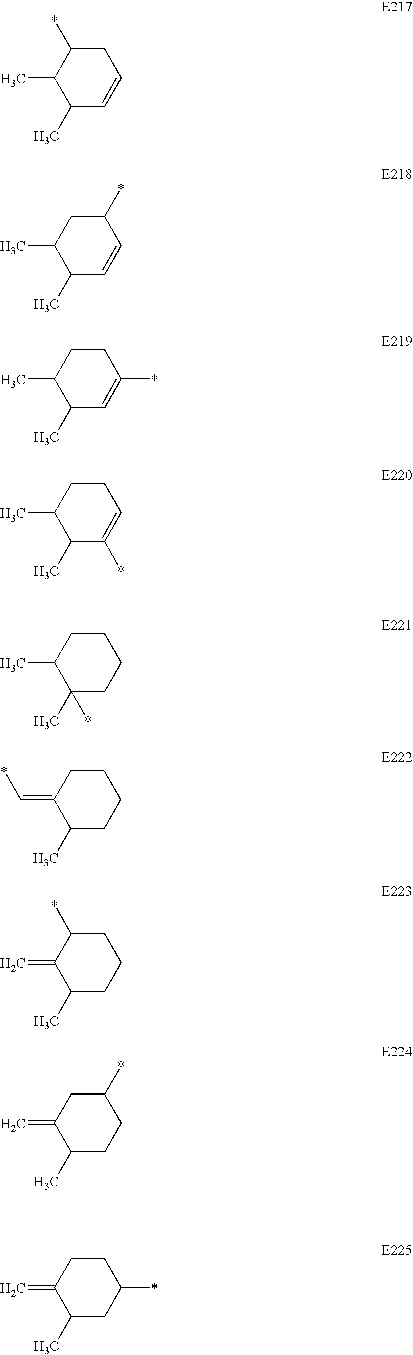

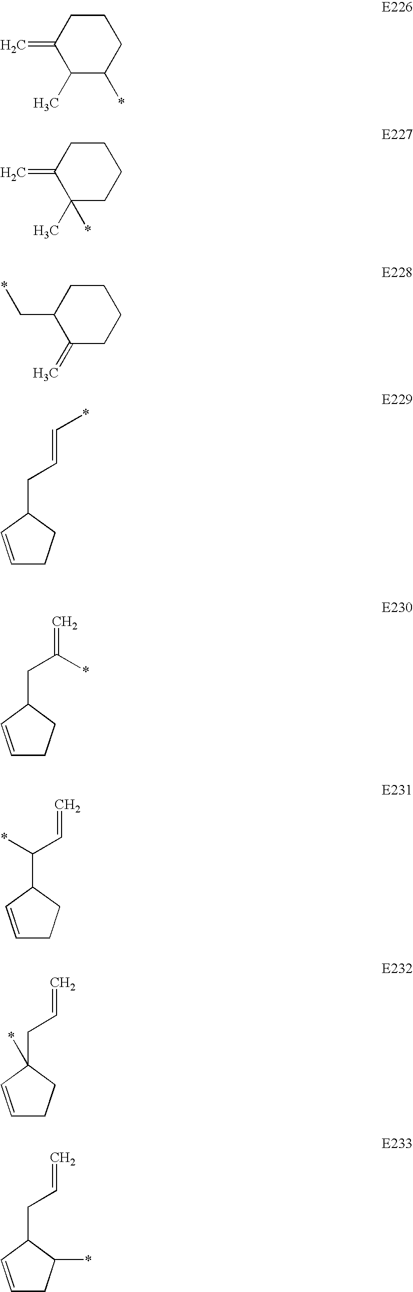

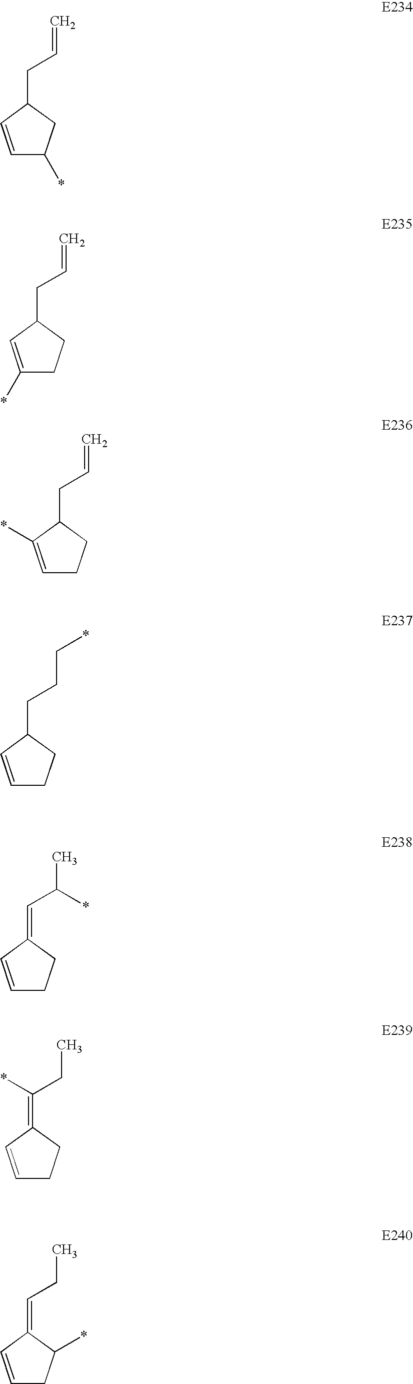

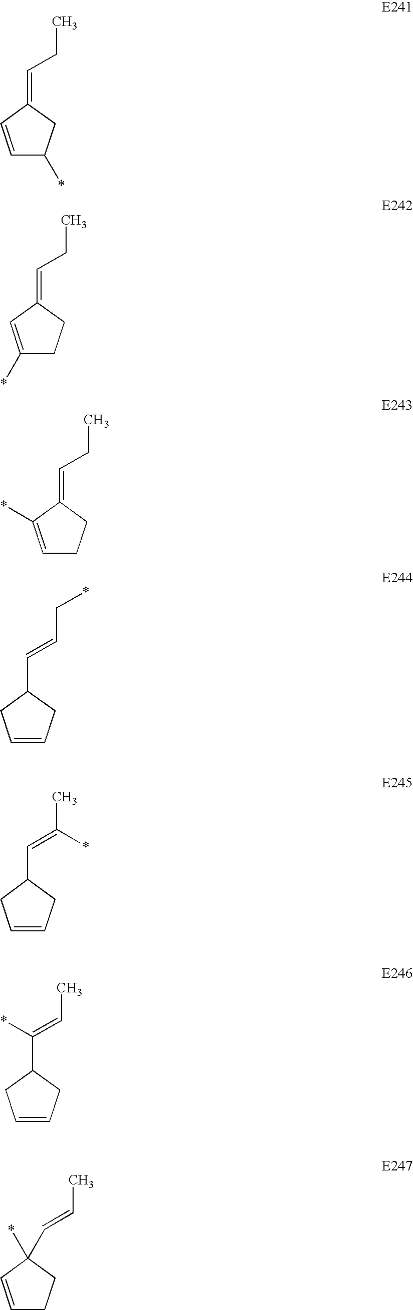

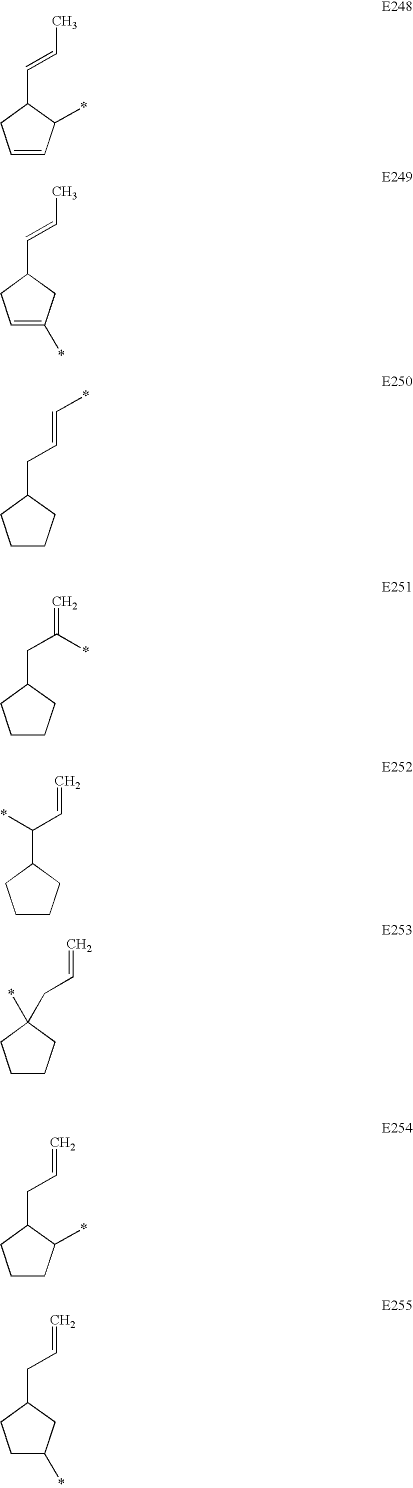

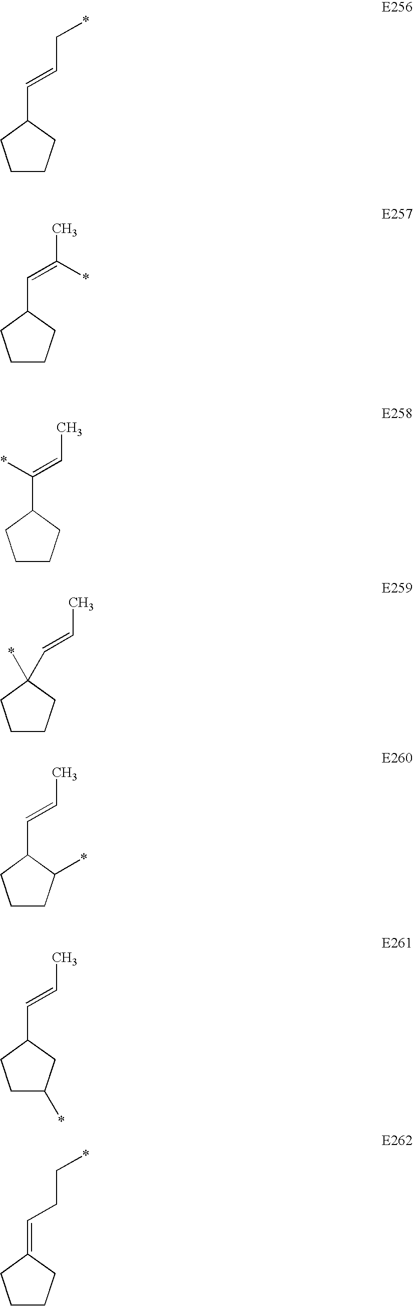

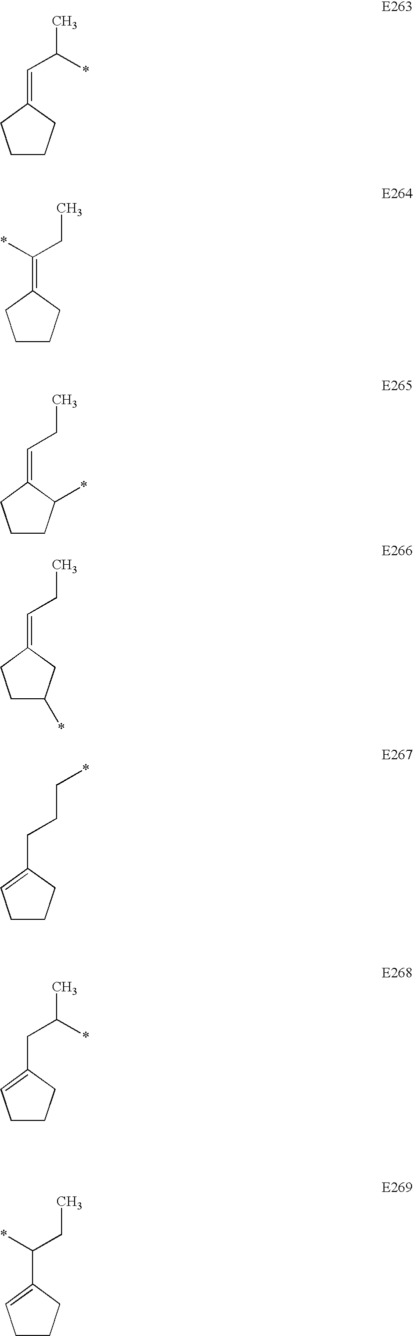

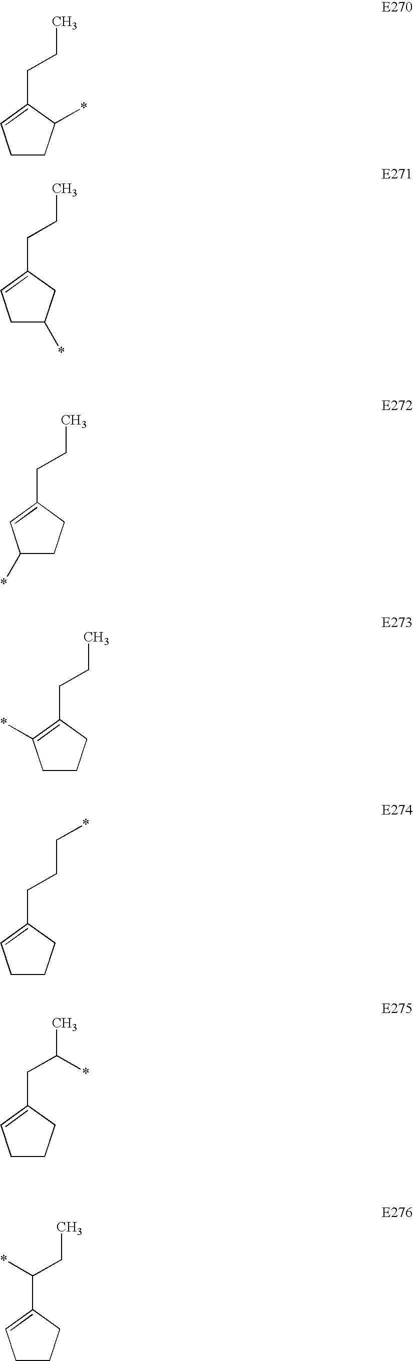

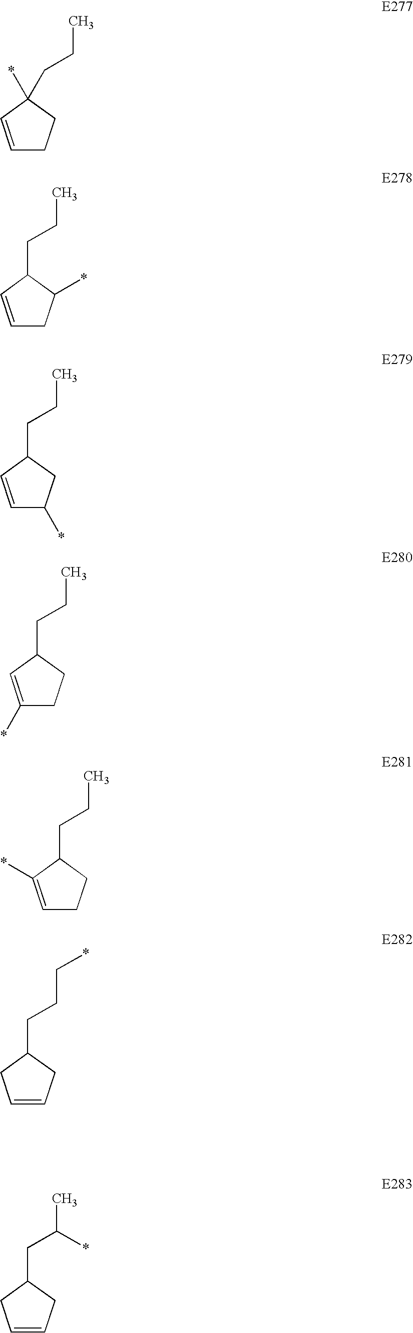

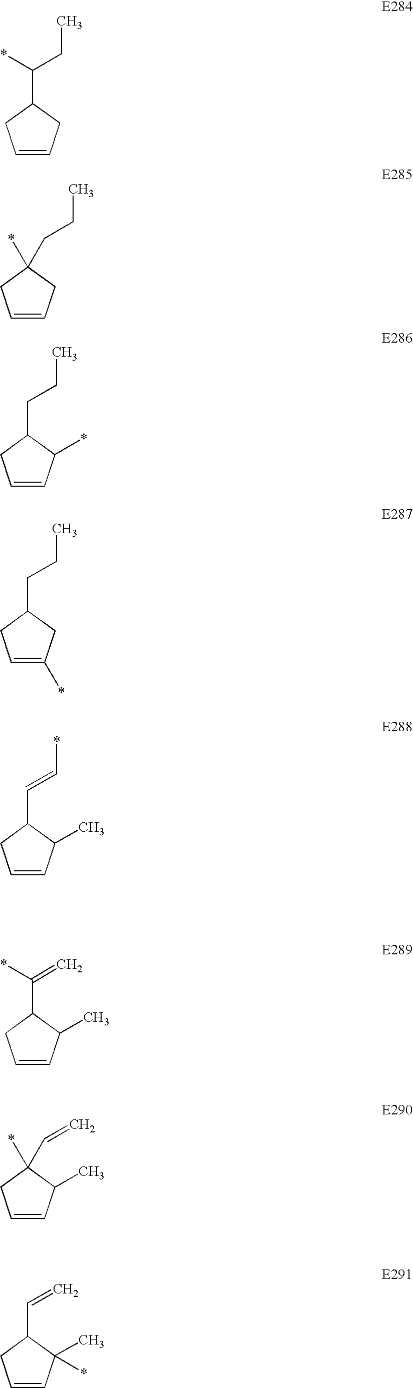

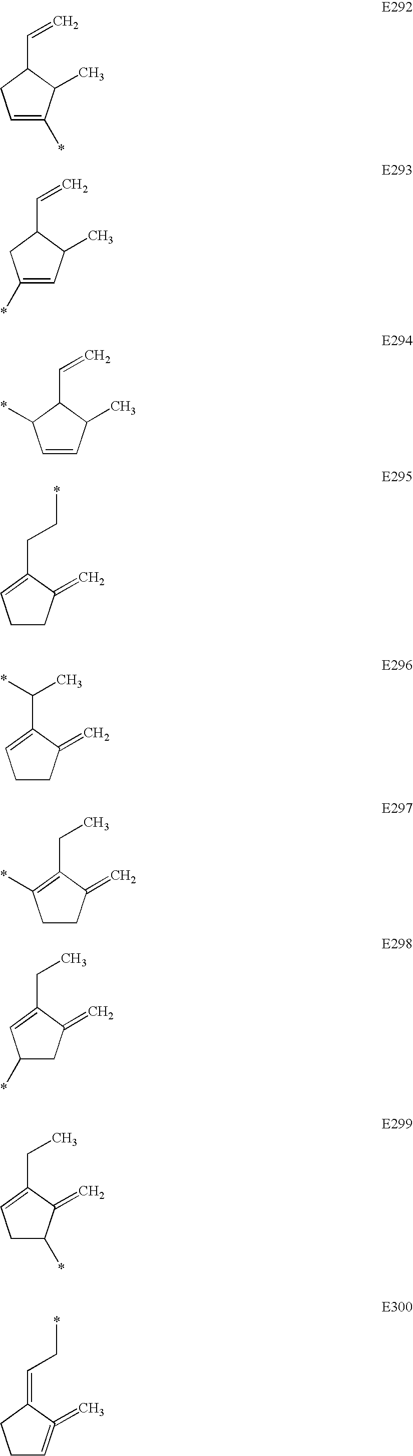

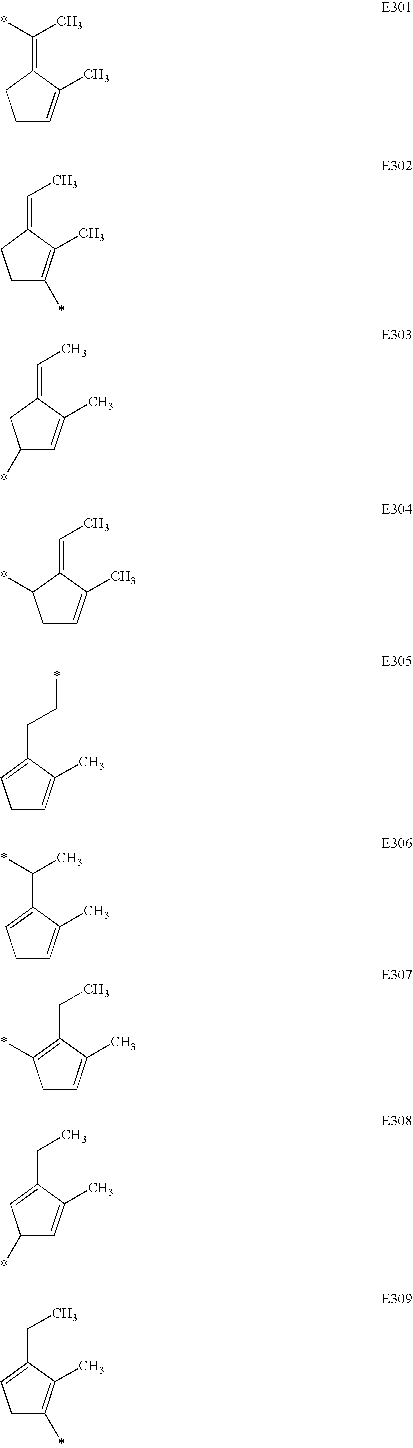

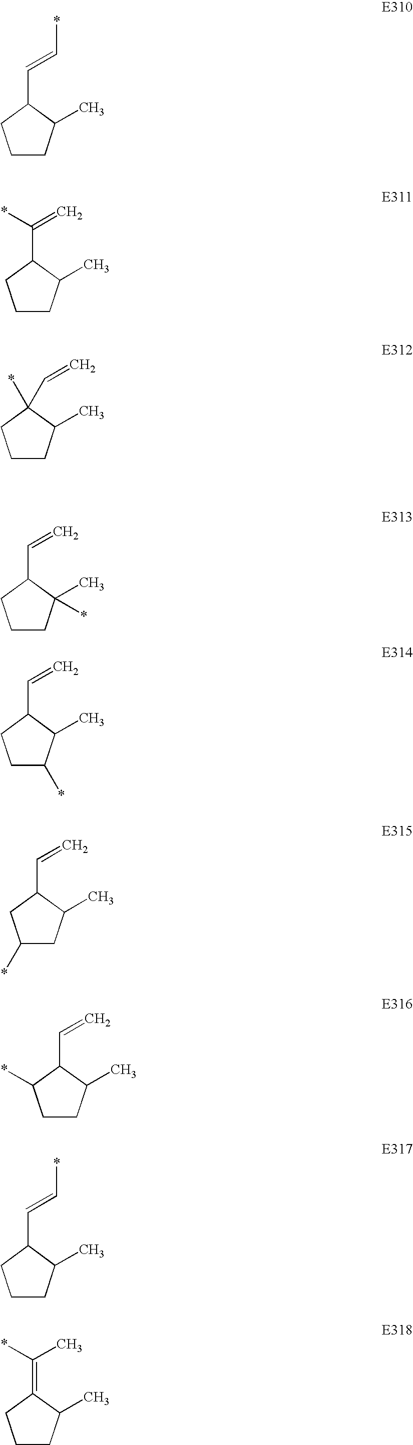

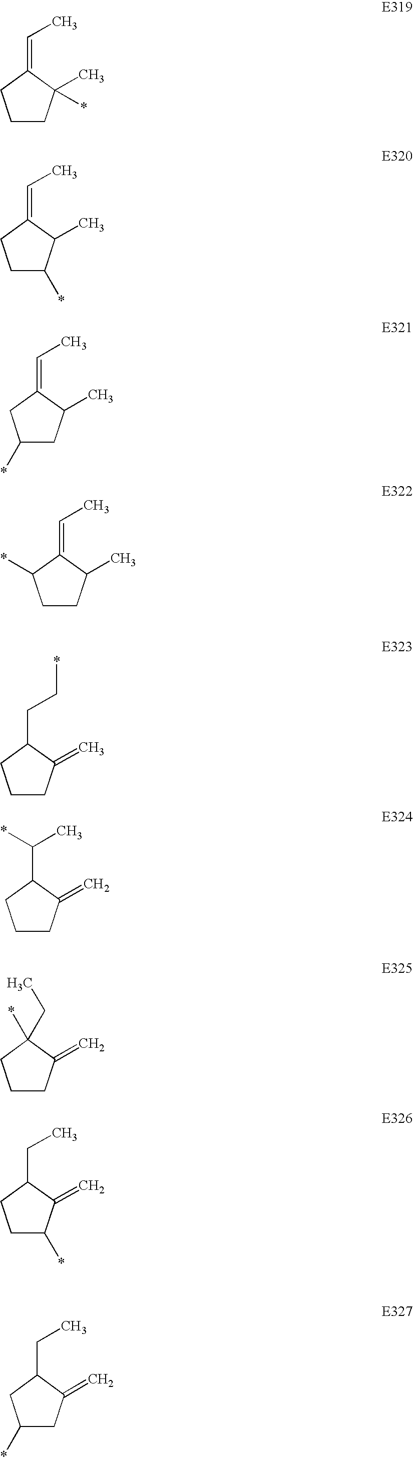

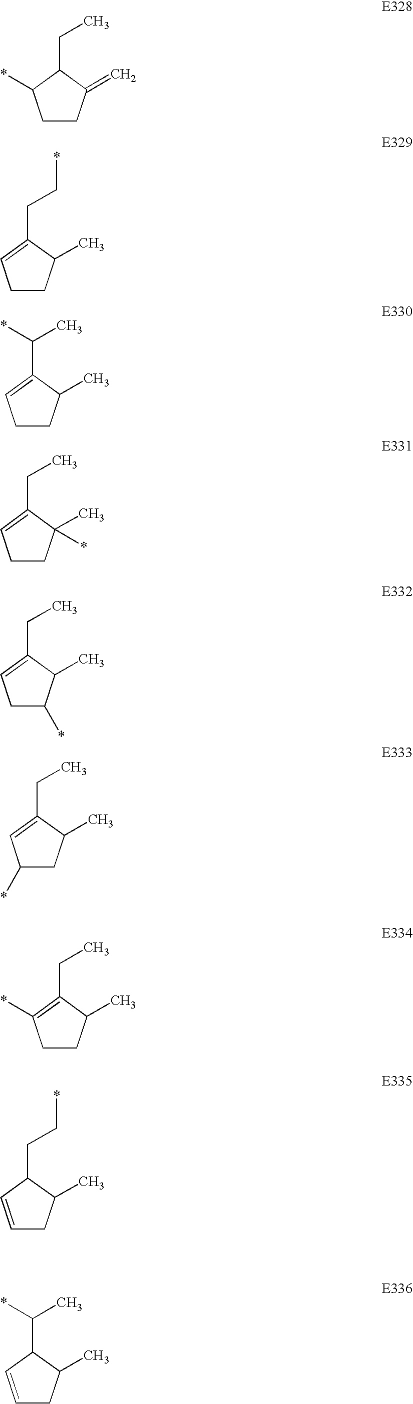

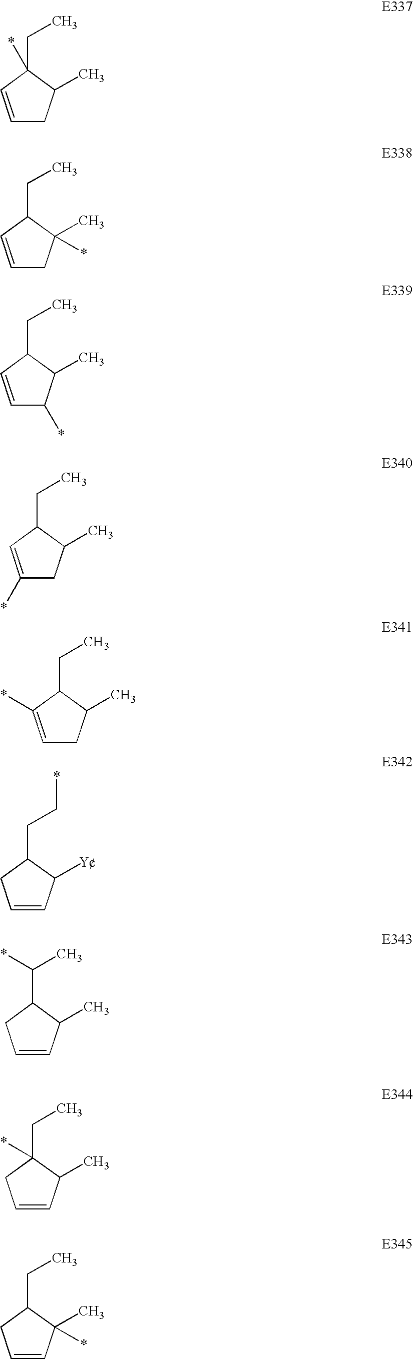

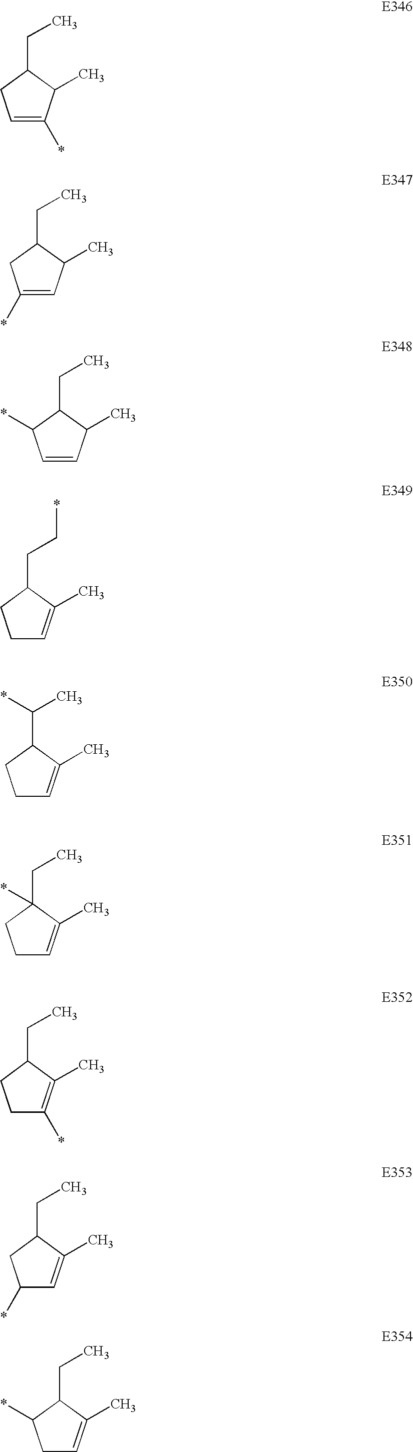

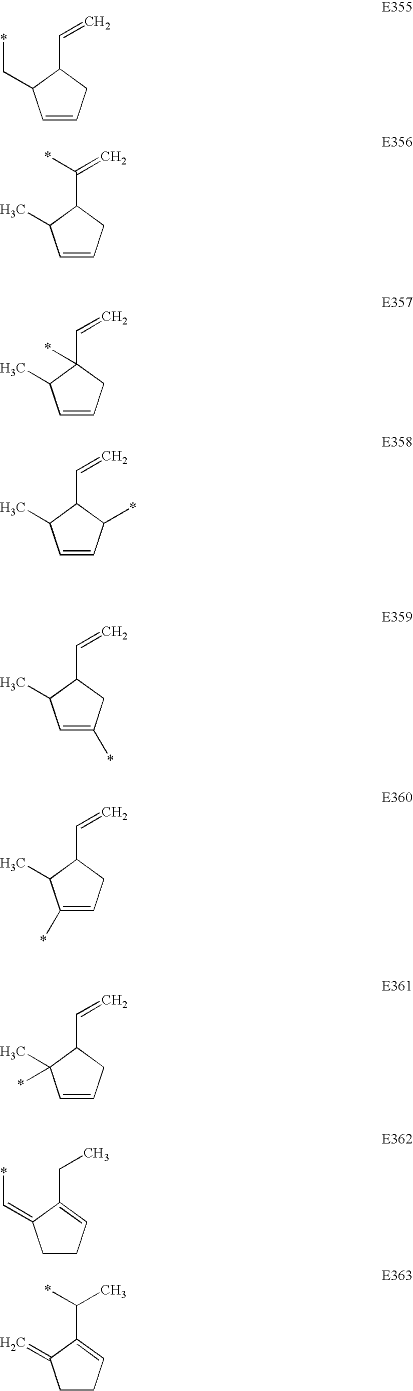

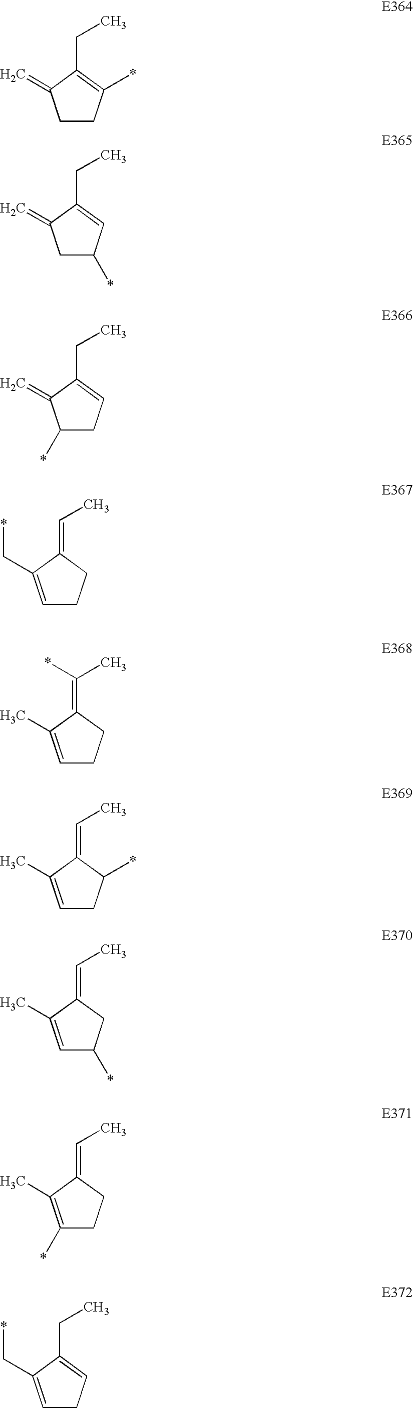

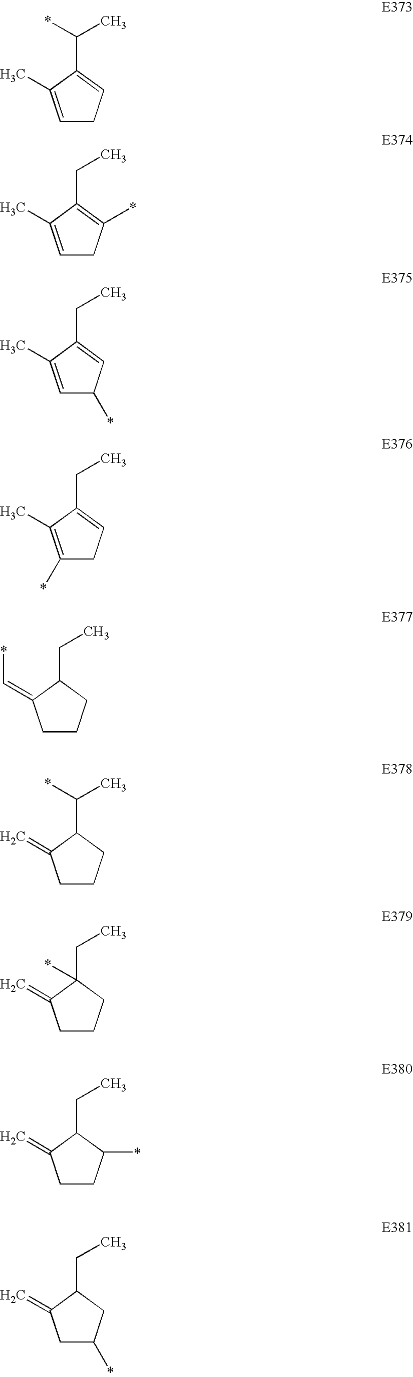

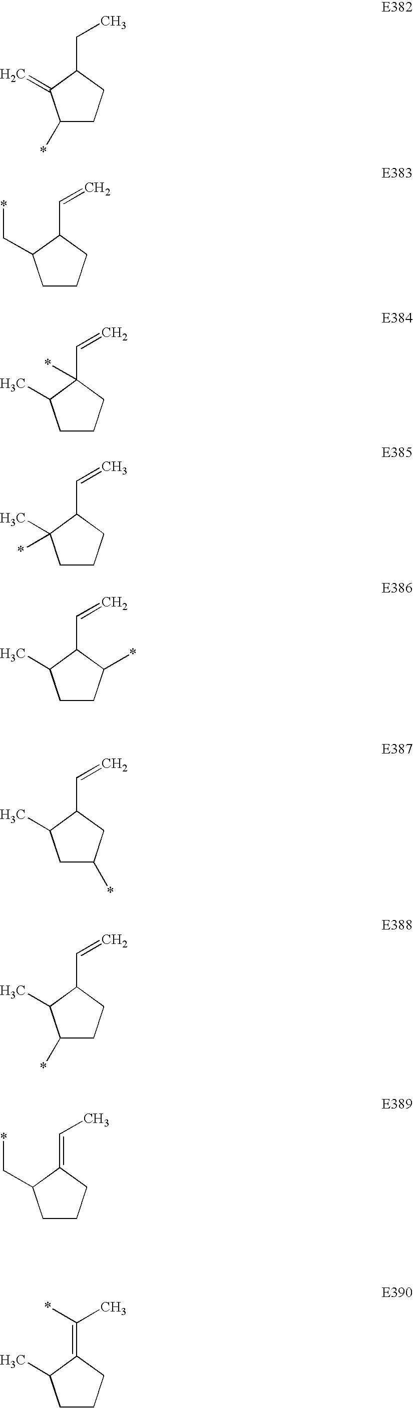

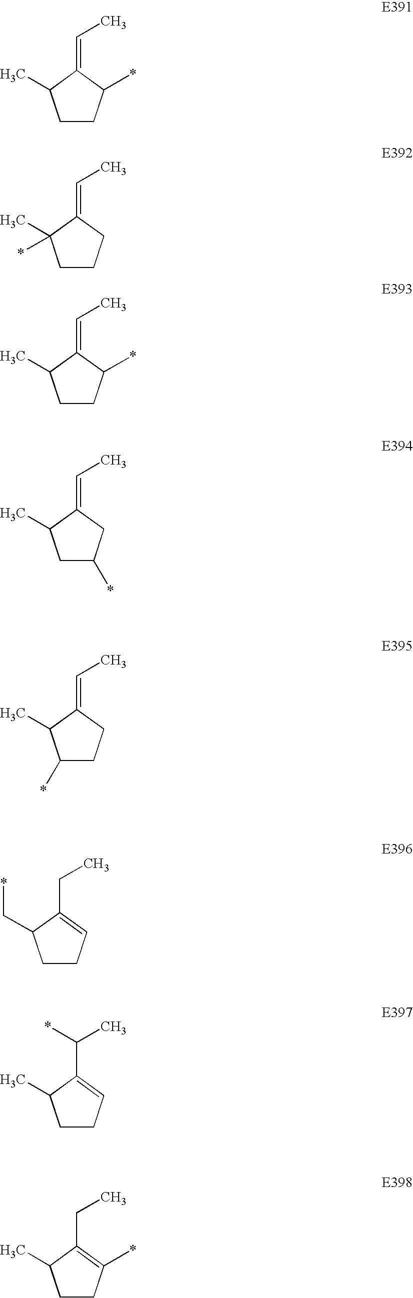

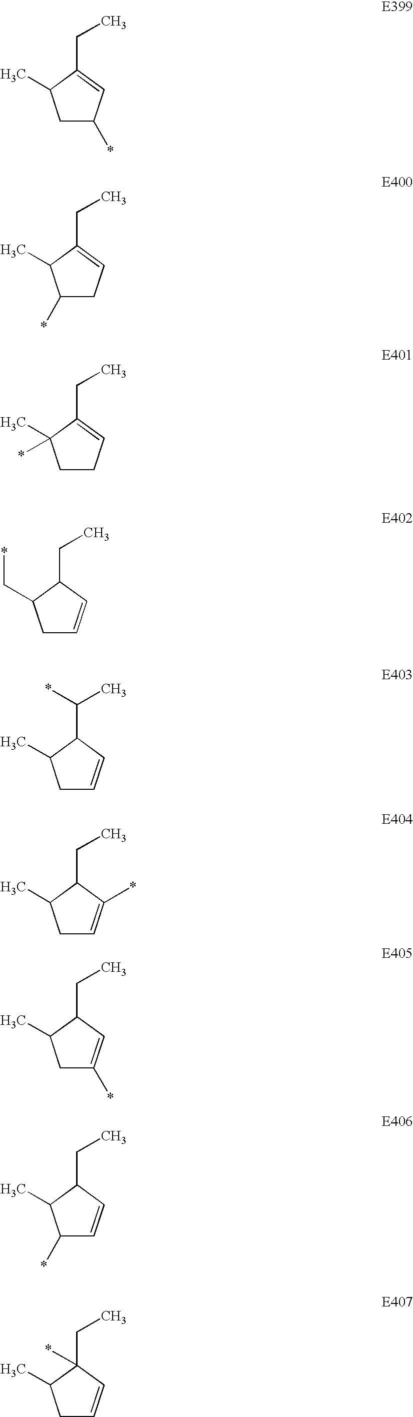

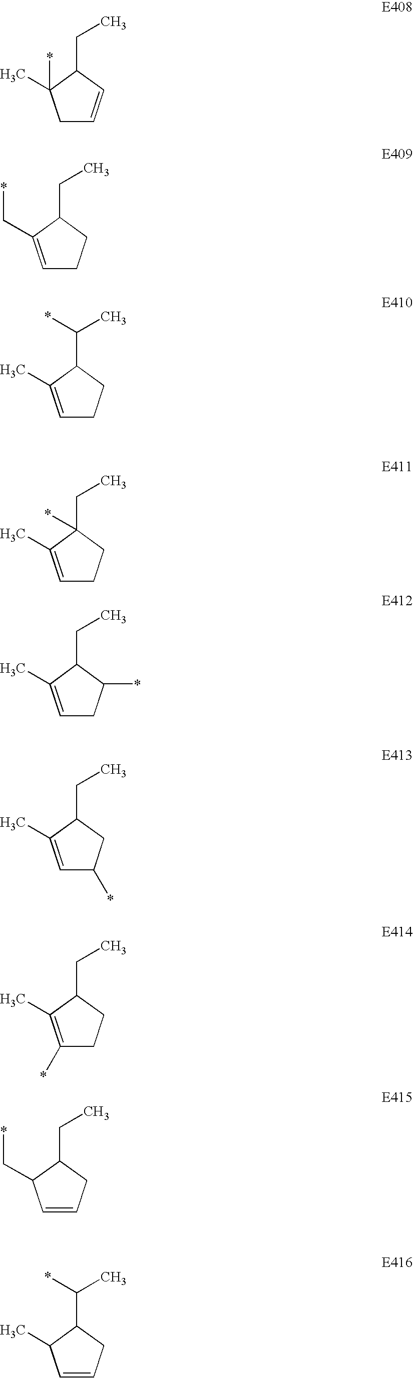

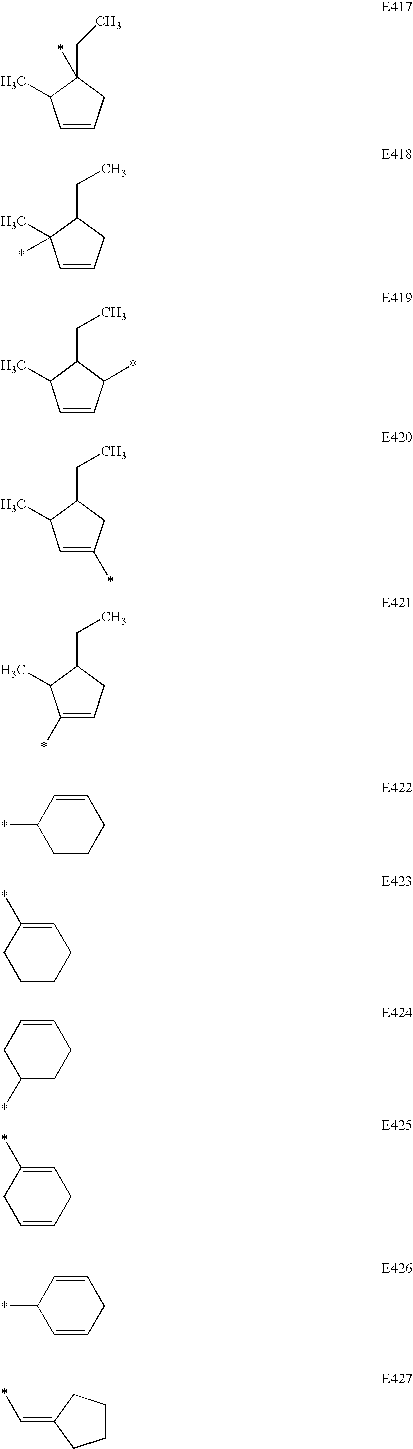

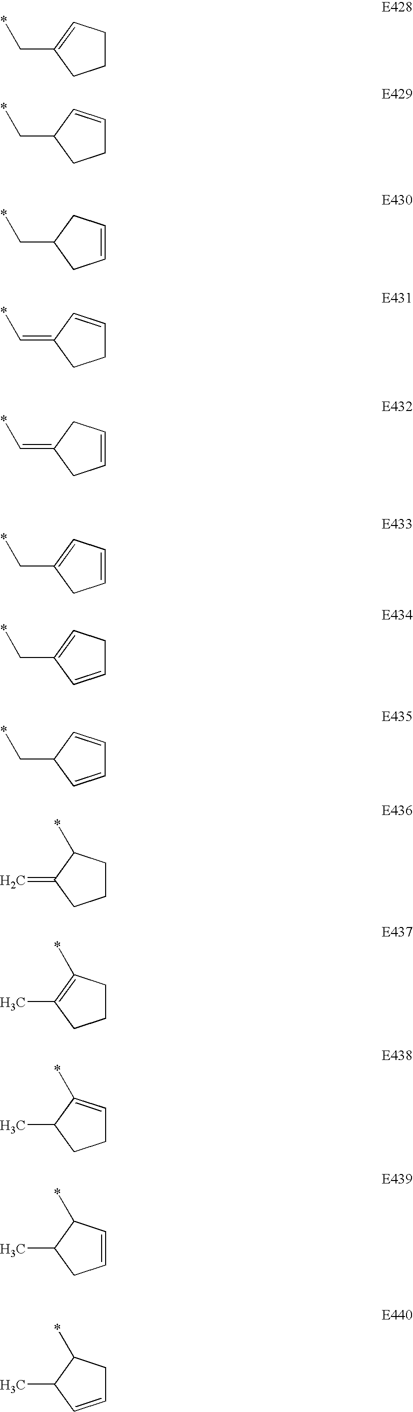

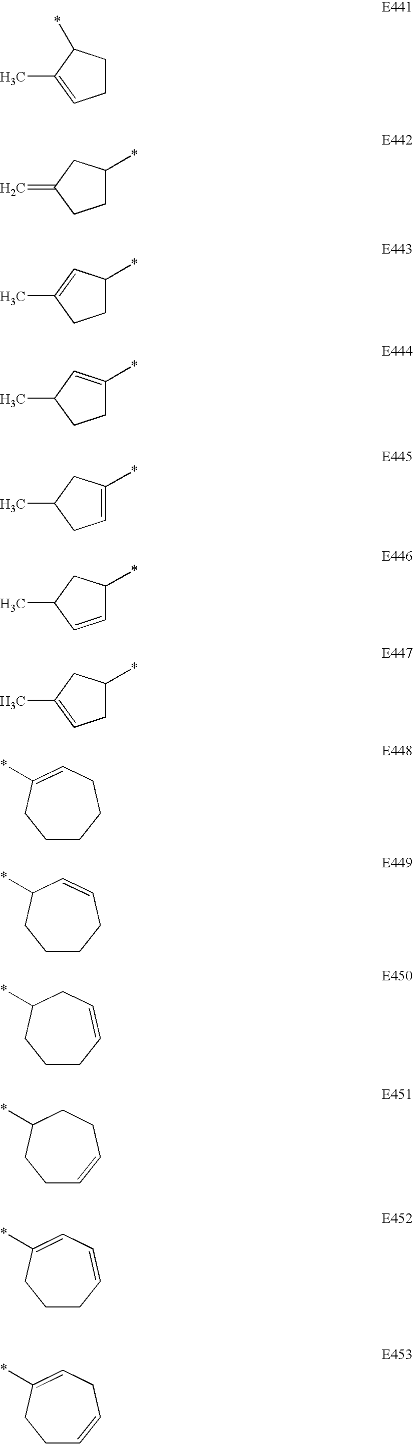

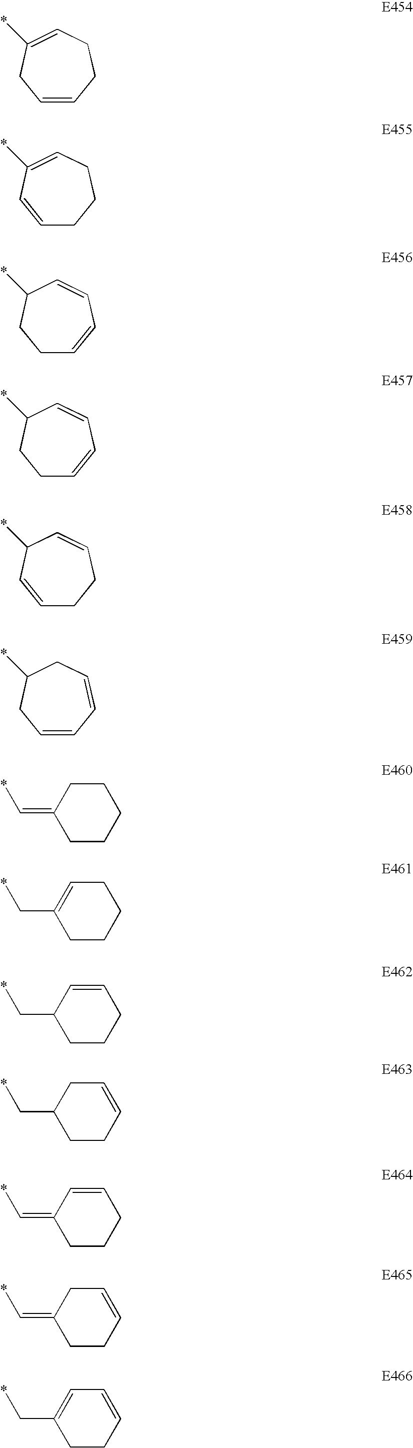

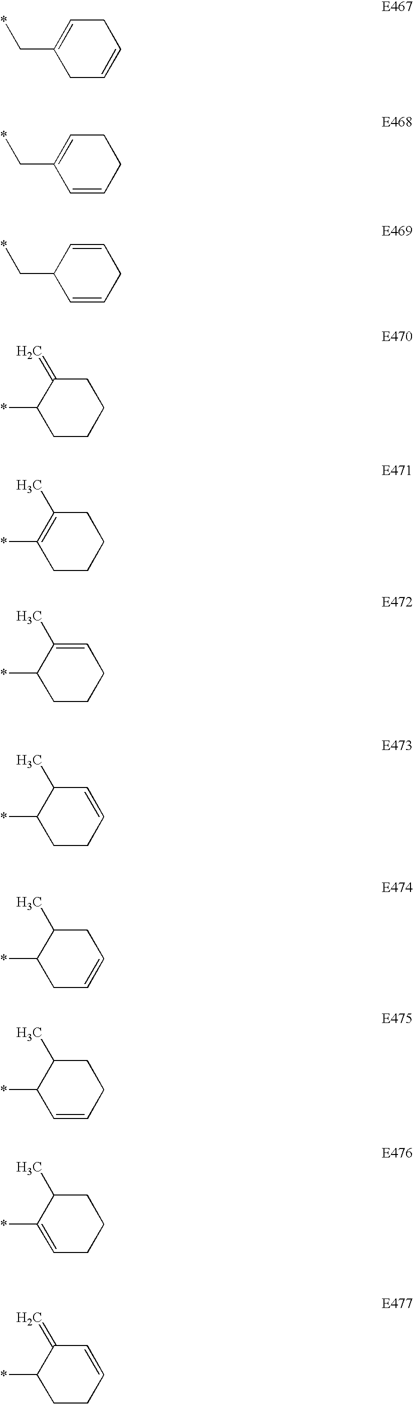

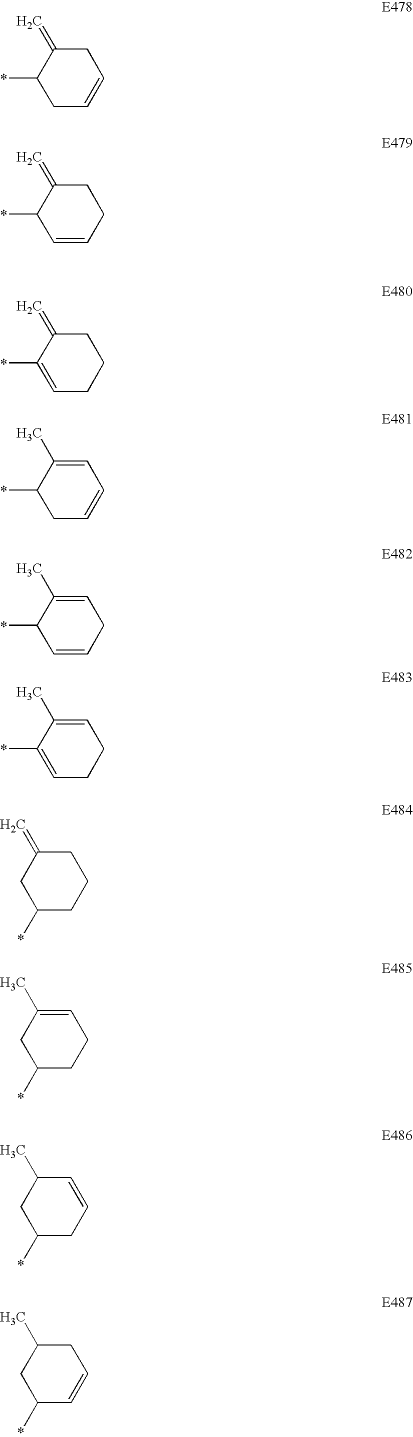

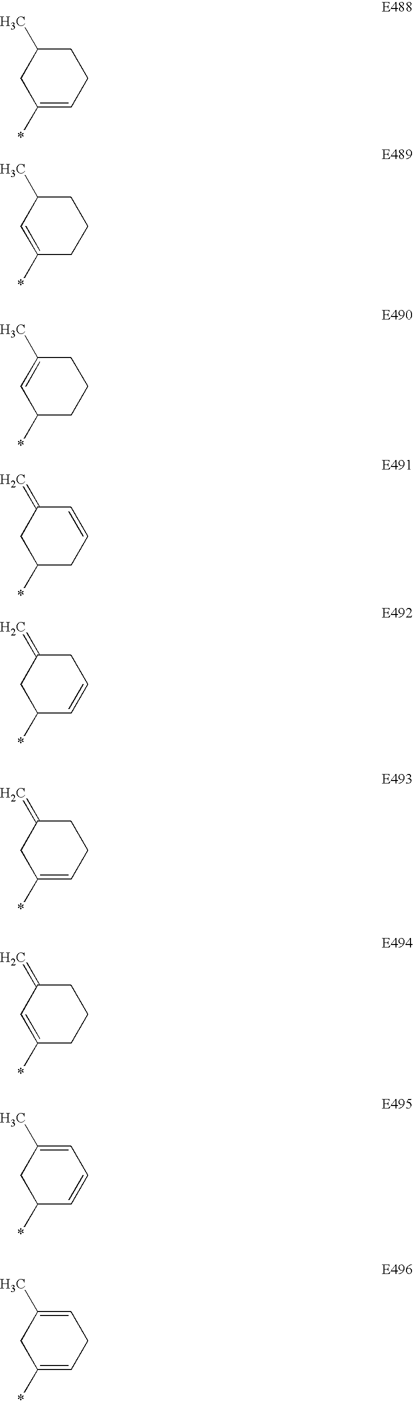

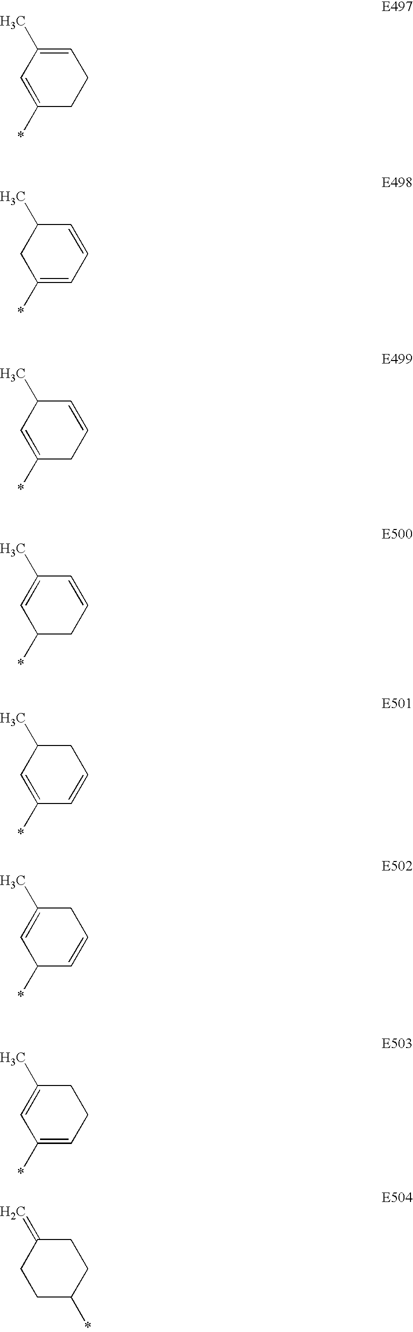

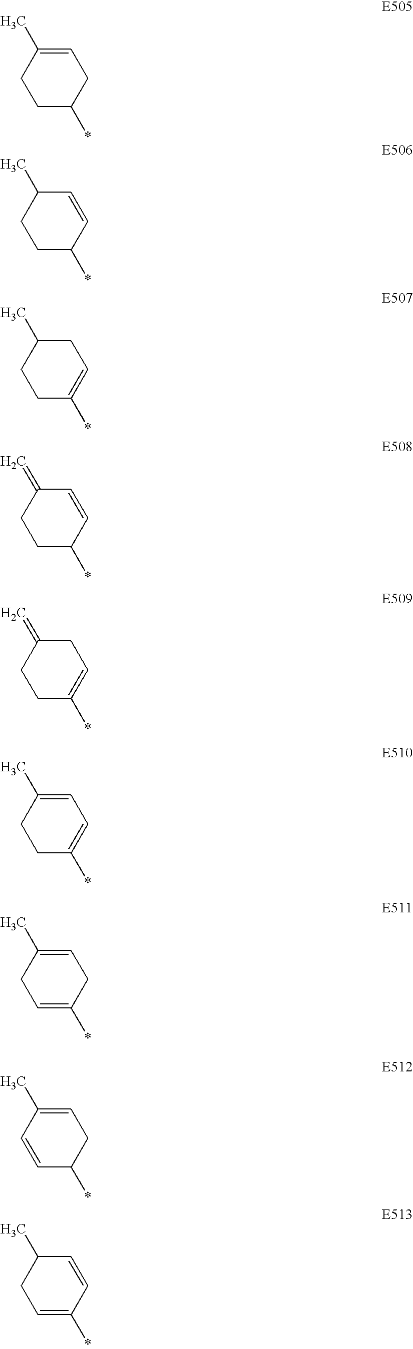

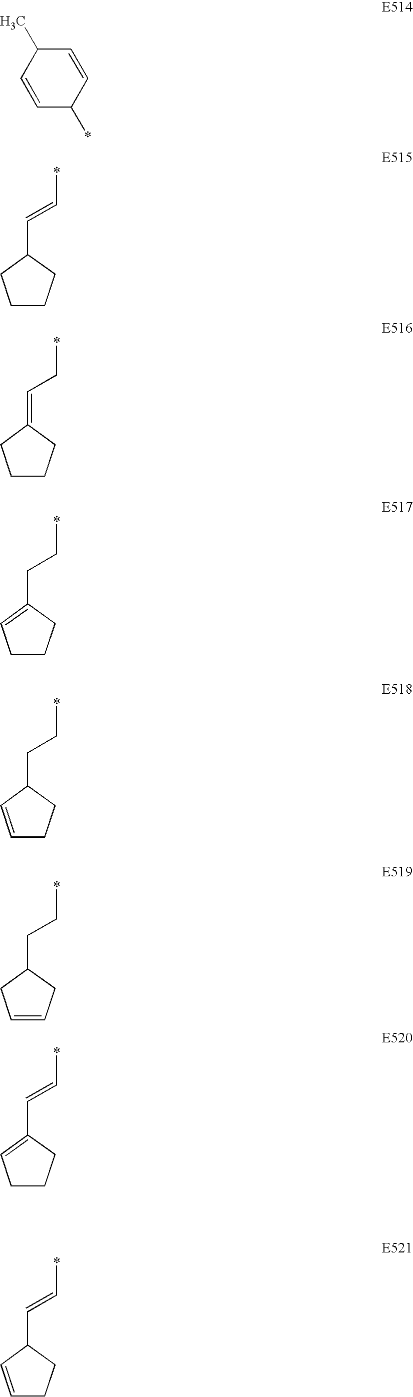

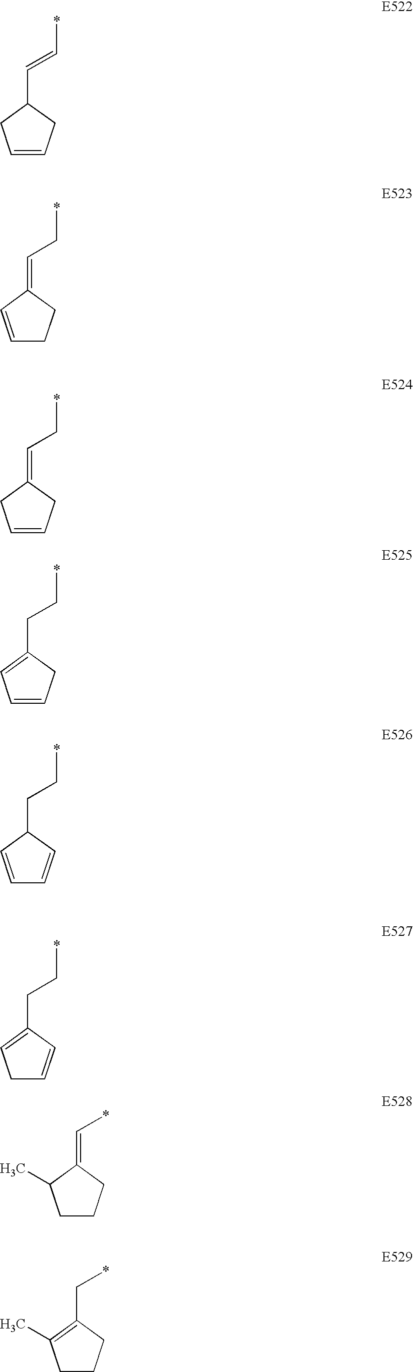

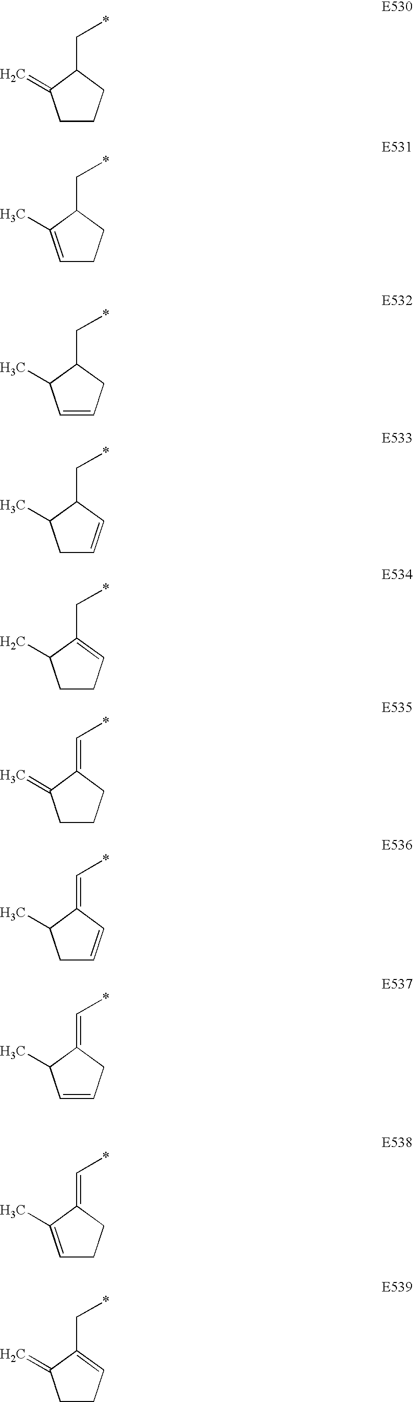

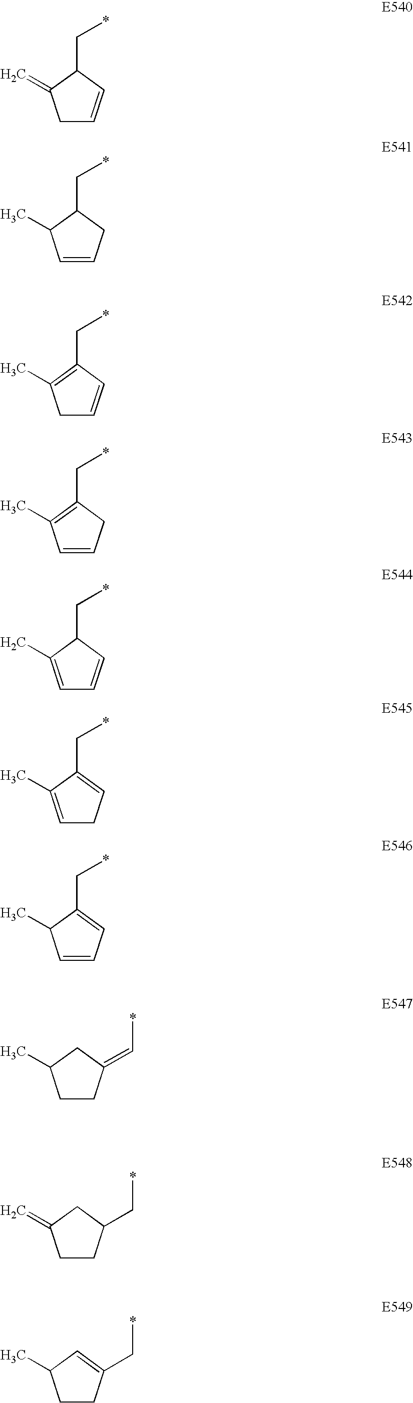

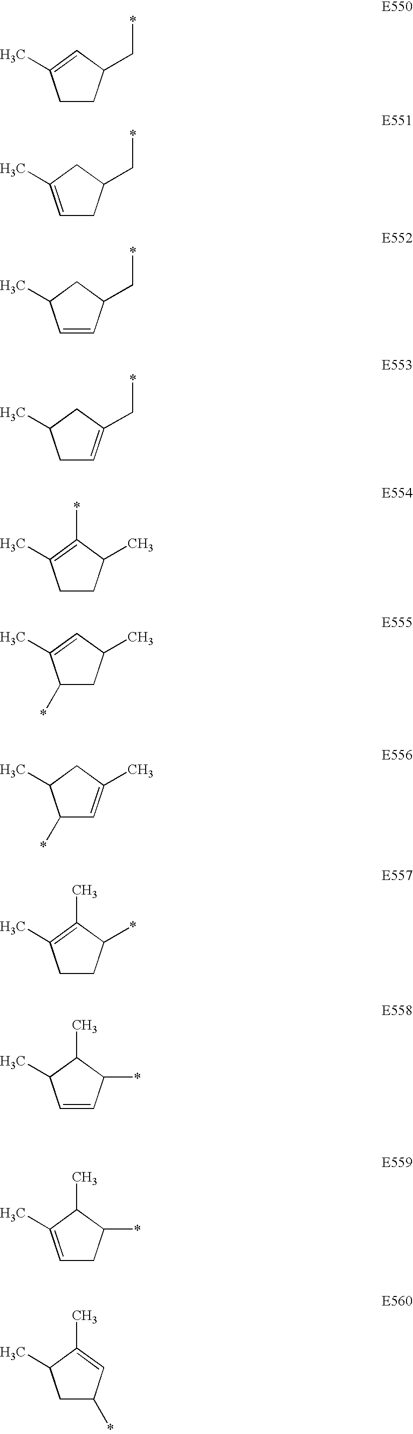

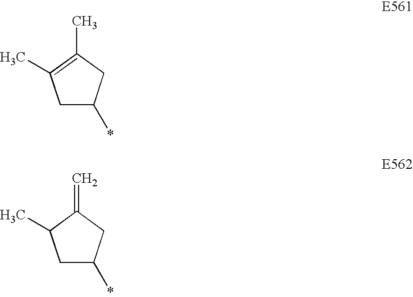

In the above formula, * represents a bonding part to main chain.

It is preferable that the unsaturated hydrocarbon group free of aromatic ring does not contain a methyl group.

Namely, in the above examples, followings are more preferable. E002, E039, E045, E046, E048, E049, E056, E060, E067, E076, E077, E078, E079, E080, E081, E086, E089, E091, E092, E093, E109, E113, E116, E118, E119, E136, E137, E138, E139, E140, E141, E142, E143, E144, E145, E146, E147, E148, E149, E150, E151, E158, E165, E172, E179, E180, E181, E182, E183, E190, E194, E195, E196, E197, E198, E228, E229, E230, E231, E232, E233, E234, E235, E236, E237, E244, E250, E251, E252, E253, E254, E255, E256, E262, E267, E274, E282, E295, E323, E355, E383, E422, E423, E424, E425, E426, E427, E428, E429, E430, E431, E432, E433, E434, E435, E436, E442, E448, E449, E450, E451, E452, E453, E454, E455, E456, E457, E458, E459, E460, E461, E462, E463, E464, E465, E466, E467, E468, E469, E470, E477, E478, E479, E480, E484, E491, E492, E493, E494, E504, E508, E509, E515, E516, E517, E518, E519, E520, E521, E522, E523, E524, E525, E526, E527, E530, E535, E539, E540, E541, and E548 are preferable, and E136, E137, E142, E143, E144, E145, E146, E147, E148, E149, and E150.

It is preferable that the unsaturated hydrocarbon group free of aromatic ring is a group represented by the following formula (2) and being free of aromatic ring:
CᵢH₂₍ᵢ₋ⱼ₎₋₁— (2)
wherein i is an integer of 5 or more, and j is an integer satisfying the range of 0 j<i/2. The i is usually 20 or less.

It is preferable that the i is 8 and the j is any one of 0, 1 or 2 in formula (2), or more preferable is cyclooctadienyl group.

Of the unsaturated hydrocarbon group free of aromatic ring, a group derived from cycloalkadiene is preferable. That the polymer has cycloalkadiene-derived group at least at one terminal end of its molecular chain means a state that polymerization reaction is carried out by addition of cycloalkadiene or a compound of cycloalkadiene having a leaving group, followed by the cycloalkadiene portion of the compound being coupled with at least at one end of the repeating unit of the polymer.

When 1,5-cyclooctadiene is used as an example of cycloalkadiene, following cases are exemplified: a structure in which a monovalent hydrocarbon group derived from 1,5-cyclooctadiene after leaving one hydrogen atom therefrom is replaced with a leaving group of the monomers used for polymerization; a structure in which a divalent hydrocarbon group resulting from 1,5-cyclooctadiene after one of double bonds thereof being opened is coupled at its one end with hydrogen atom and replaced at its another end with a leaving group of the monomers used for polymerization, or an isomeric structure thereof having different bonding site with the repeating units of the polymer; or a structure in which one more double bond is increased after the ring thereof being broken, or an isomeric structure thereof.

Of the polymer of the invention, at least one terminal end of molecular chain thereof is an unsaturated hydrocarbon group free of aromatic ring. The unsaturated hydrocarbon group free of aromatic ring may be one kind, two kinds or more. It is preferable for the polymer of the invention that the content of a polymer having at both ends thereof the unsaturated hydrocarbon groups free of aromatic ring is more than that of a polymer having at only one end thereof the unsaturated hydrocarbon group free of aromatic ring; or more preferably that the content of a polymer having at both ends thereof the unsaturated hydrocarbon groups free of aromatic ring is equal to or more than two times of that of a polymer having at only one end thereof the unsaturated hydrocarbon group free of aromatic ring.

Of the terminal ends of the polymer of the invention, a terminal end other than the unsaturated hydrocarbon group free of aromatic ring is preferably a terminal end group derived from monomers used for polymerization of which one of leaving groups is substituted by hydrogen atom (referred to as a hydrogen-substituted terminal end group hereinafter). The content of terminal end groups other than the unsaturated hydrocarbon group free of aromatic ring and the hydrogen-substituted terminal end group is preferably 30% or less based on that of total terminal ends, more preferably 20% or less, still more preferably 10% or less, or most preferably not being existed.

When, for example, the polymer of the invention is produced by using a monomer having halogen atom as a raw material therefor, since halogen atom remained at the polymer terminal end tends to degrade fluorescence property and the like, it is preferable that halogen atom is substantially not remained at the terminal ends.

A ratio of a polymer coupled with a terminal end group to the whole polymers can be calculated by comparing intensities of mass spectrum obtained by a Matrix Assisted Laser Desorption Ionization Time-of-flight Mass Spectrometry. For example, when, over the whole range of mass number peaks of the polymer detected in the mass spectrum, an intensity of mass number peak of a polymer having at both ends thereof aliphatic hydrocarbon group containing unsaturated bond is greater than that of a polymer having at only one end thereof aliphatic hydrocarbon group containing unsaturated bond, the content of the polymer having at both ends thereof aliphatic hydrocarbon group containing unsaturated bond is deemed to be grater than that of the polymer having at only one end thereof aliphatic hydrocarbon group containing unsaturated bond.

The polymer of the present invention has one or more kinds of repeating units selected from the group consisting of an arylene group, a divalent heterocyclic group, and divalent aromatic amine group.

Here, the arylene group means an atomic group in which two hydrogen atoms are removed from an aromatic hydrocarbon, and includes those containing two or more of independent benzene rings or condensed rings bonded through a group such as a direct bond, a vinylene group or the like.

The number of carbon atoms constituting the ring of the arylene group is usually about 6 to 60. As the arylene groups, specifically exemplified are: phenylene group, fluorenediyl group, biphenylene group, terphenylene group, naphthalenediyl group, anthracenediyl group, phenanthrene diyl group, pentalenediyl group, indenediyl group, heptalenediyl group, indacenediyl group, triphenylenediyl group, binaphthyldiyl group, phenylnaphthylenediyl group, stilbenediyl group, 3,3′-alkoxystilbenediyl group, etc.; and preferably, phenylene group and fluorenediyl group.

As the phenylene group, for example, following groups are exemplified.

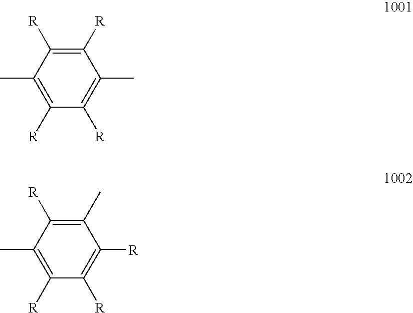

As the fluorenediyl group, for example, following groups are exemplified.

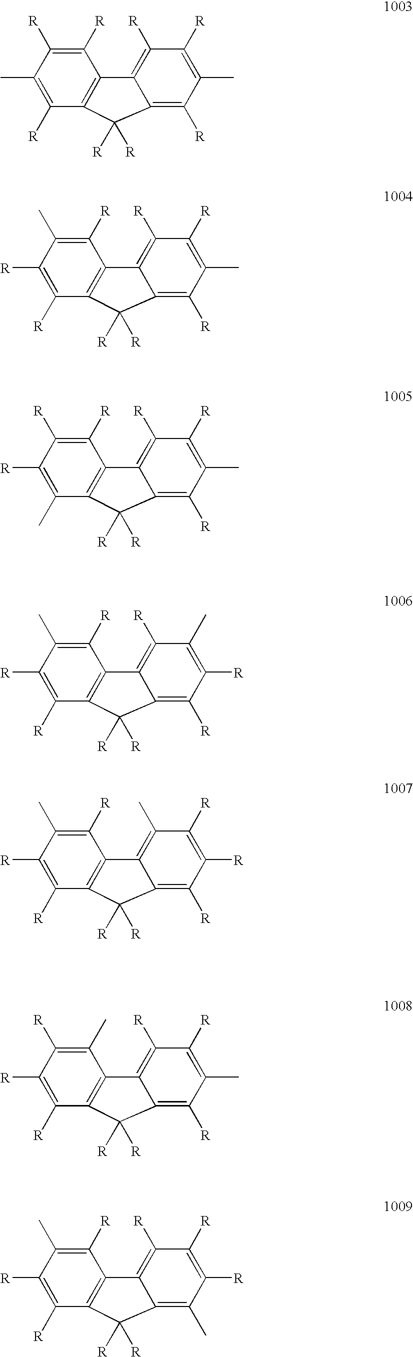

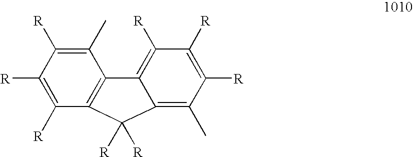

Here, as R, a hydrogen atom, alkyl group, alkoxy group, alkylthio group, alkylsilyl group, alkylamino group, hydroxyl group, amino group, carboxyl group, aldehyde group, cyano group, etc. are exemplified; and alkyl group, alkoxy group, hydroxyl group, amino group, carboxyl group, and aldehyde group are preferable.

In the above formula, a plurality of Rs are contained in one group, they may be the same or different with each other.

The alkyl group may be any of linear, branched or cyclic, and usually has about 1 to 20 carbon atoms, and specific examples thereof include methyl group, ethyl group, propyl group, i-propyl group, butyl group, i-butyl group, t-butyl group, pentyl group, isoamyl group, hexyl group, cyclohexyl group, heptyl group, octyl group, 2-ethylhexyl group, nonyl group, decyl group, 3,7-dimethyloctyl group, lauryl group, etc.

The alkoxyl group may be any of linear, branched or cyclic, and usually has about 1 to 20 carbon atoms, and specific examples thereof include methoxy group, ethoxy group, propyloxy group, i-propyloxy group, butoxy group, i-butoxy group, t-butoxy group, pentyloxy group, isoamyl oxy group, hexyloxy group, cyclohexyloxy group, heptyloxy group, octyloxy group, 2-ethylhexyloxy group, nonyloxy group, decyloxy group, 3,7-dimethyloctyloxy group, lauryloxy group, etc.

The alkylthio group may be any of linear, branched or cyclic, and usually has about 1 to 20 carbon atoms, and specific examples thereof include methylthio group, ethylthio group, propylthio group, i-propylthio group, butylthio group, i-butylthio group, t-butylthio group, pentylthio group, hexylthio group, cyclohexylthio group, heptylthio group, octylthio group, 2-ethylhexylthio group, nonylthio group, decylthio group, 3,7-dimethyloctylthio group, laurylthio group, etc.

The alkylsilyl group may be any of linear, branched or cyclic, and usually has about 1 to 60 carbon atoms, and specific examples thereof include methylsilyl group, ethylsilyl group, propylsilyl group, i-propylsilyl group, butylsilyl group, i-butylsilyl group, t-butylsilyl group, pentylsilyl group, hexylsilyl group, cyclohexylsilyl group, heptylsilyl group, octylsilyl group, 2-ethylhexylsilyl group, nonylsilyl group, decylsilyl group, 3,7-dimethyloctylsilyl group, laurylsilyl group, trimethylsilyl group, ethyldimethylsilyl group, propyldimethylsilyl group, i-propyldimethylsilyl group, butyldimethylsilyl group, t-butyldimethylsilyl group, pentyldimethylsilyl group, hexyldimethylsilyl group, heptyldimethylsilyl group, octyldimethylsilyl group, 2-ethyl hexyl-dimethylsilyl group, nonyldimethylsilyl group, decyldimethylsilyl group, 3,7-dimethyloctyl-dimethylsilyl group, lauryldimethylsilyl group, etc.

The alkylamino group may be any of linear, branched or cyclic, and may be either monoalkylamino group or dialkylamino group. The number of carbon atoms are usually about 1 to 40, and specific examples thereof include methylamino group, dimethyl amino group, ethylamino group, diethylamino group, propylamino group, i-propylamino group, butylamino group, and i-butylamino group, t-butylamino group, pentylamino group, hexylamino group, cyclohexylamino group, heptylamino group, octylamino group, 2-ethylhexylamino group, nonylamino group, decylamino group, 3,7-dimethyloctylamino group, laurylamino group, etc.

The divalent heterocyclic group means an atomic group in which two hydrogen atoms are removed from a heterocyclic compound, and the number of carbon atoms which constitutes a ring is usually about 4 to 60.

Examples of the divalent heterocyclic group include: 6 membered heterocyclic groups containing a hetero atom, groups having fluorene structure containing a hetero atom, 5 membered heterocyclic groups containing a hetero atom, condensed heterocyclic groups having 5- or 6-membered heterocyclic groups containing a hetero atom; 5 membered heterocyclic groups containing a hetero atom, which are connected at the a position of the hetero atom to form a dimer or an oligomer; 5 membered heterocyclic groups containing a hetero atom, which are connected with a phenyl group at the a position of the hetero atom, etc.

As the hetero atom, nitrogen, oxygen, sulfur, silicon, and selenium are exemplified and nitrogen, oxygen, and sulfur are preferable. In the case of 6 membered-ring heterocyclic group containing a hetero atom, it is preferable that a hetero atom is nitrogen.

As the 6 membered heterocyclic groups containing a hetero atom, for example, following groups are exemplified.

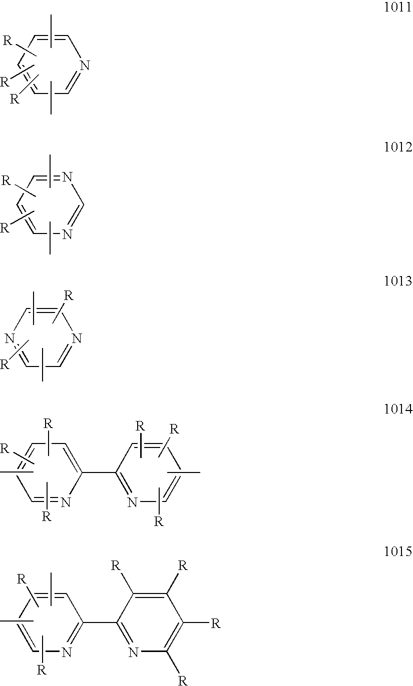

As the groups having fluorene structure containing a hetero atom, for example, following groups are exemplified.

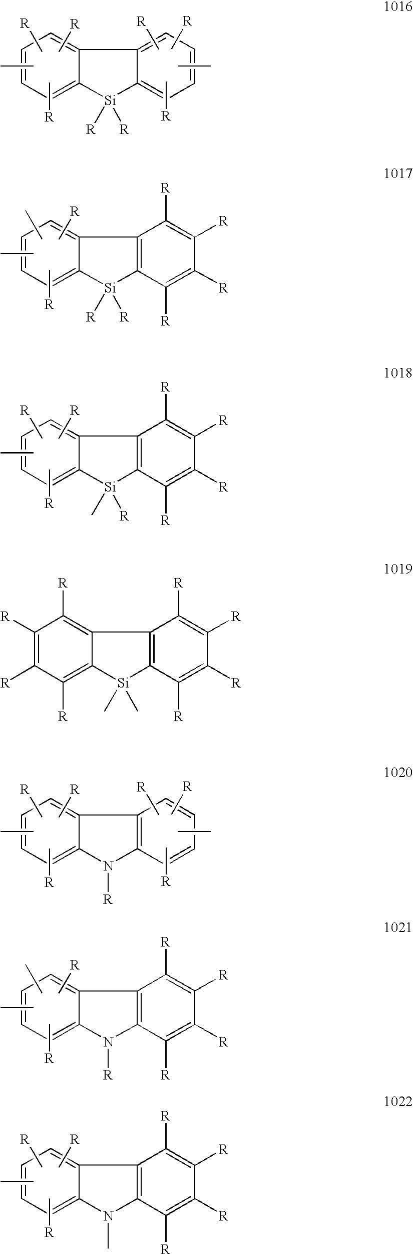

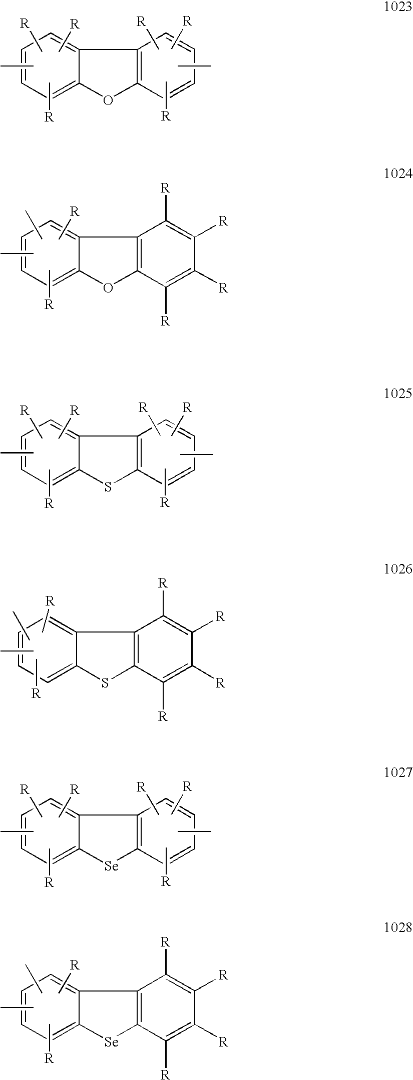

As the 5 membered heterocyclic groups containing a hetero atom, for example, following groups are exemplified.

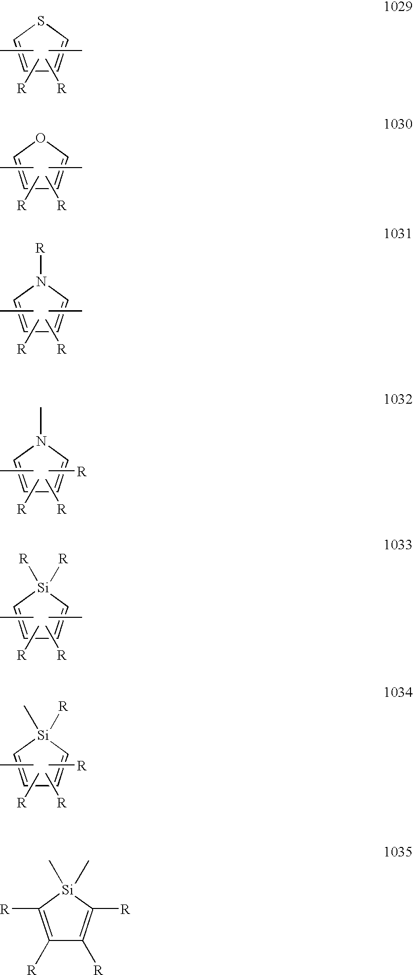

As the condensed heterocyclic groups having 5- or 6-membered heterocyclic groups containing a hetero atom, for example, following groups are exemplified.

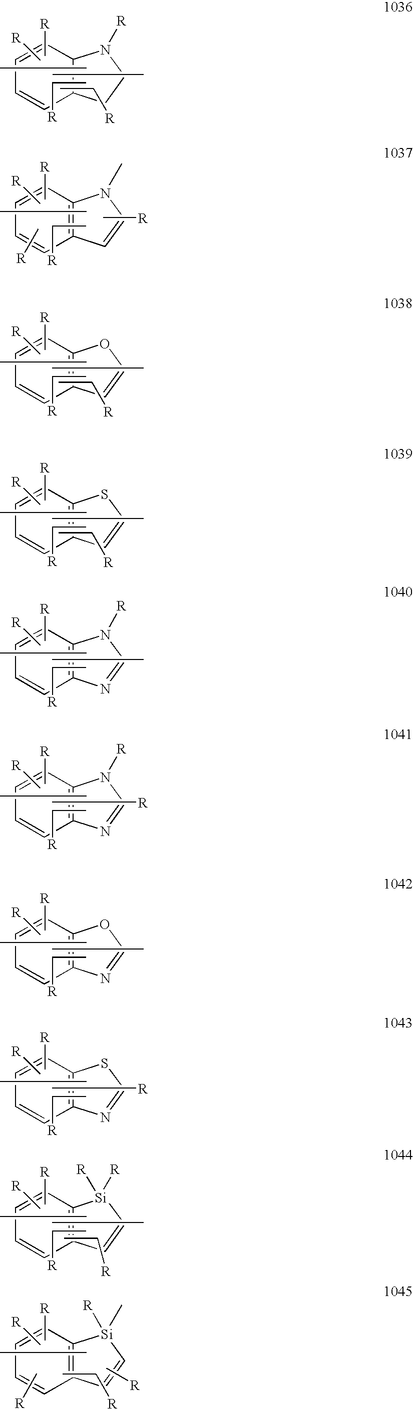

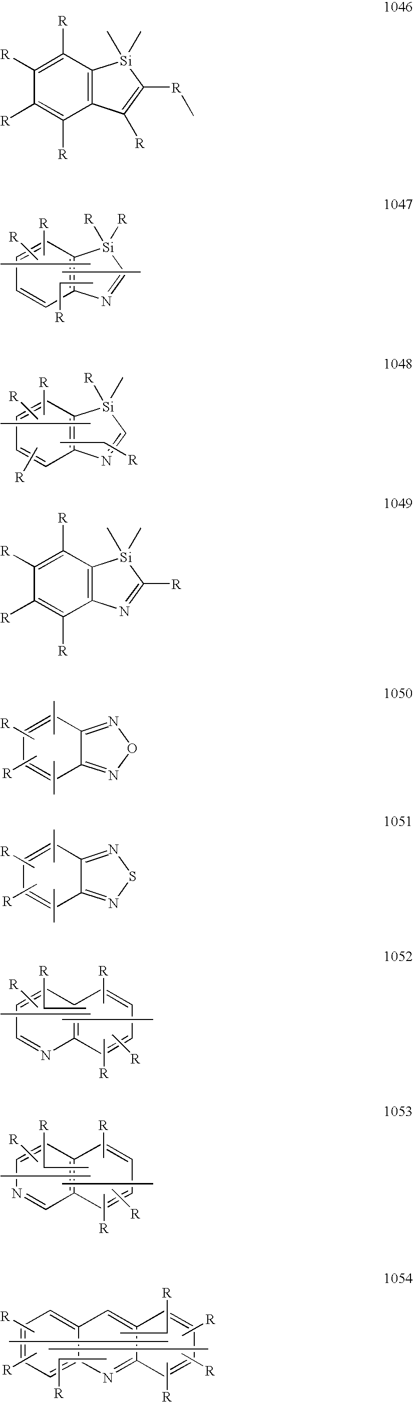

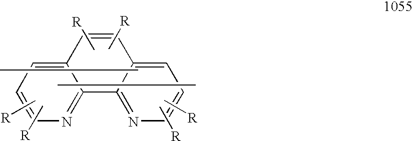

As the 5 membered heterocyclic groups containing a hetero atom, which are connected at the a position of the hetero atom to form a dimer or an oligomer, for example, following groups are exemplified.

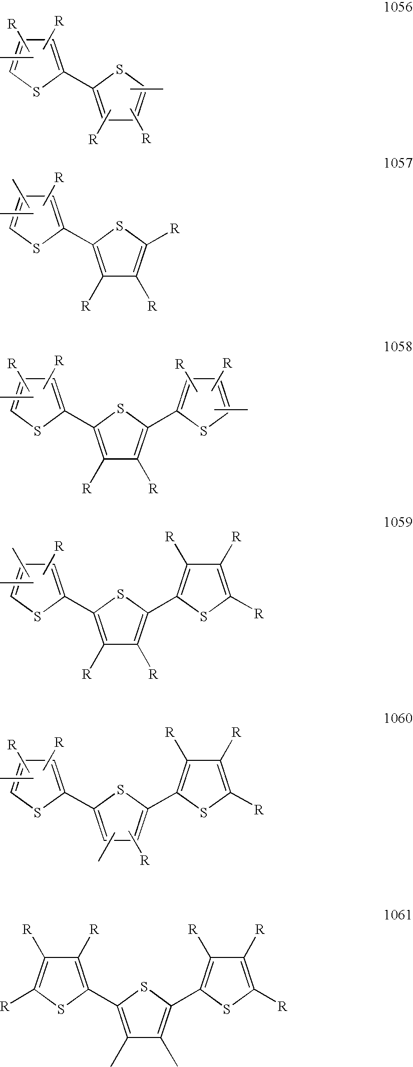

As the 5 membered heterocyclic groups containing a hetero atom, which are connected with a phenyl group at the a position of the hetero atom, for example, following groups are exemplified.

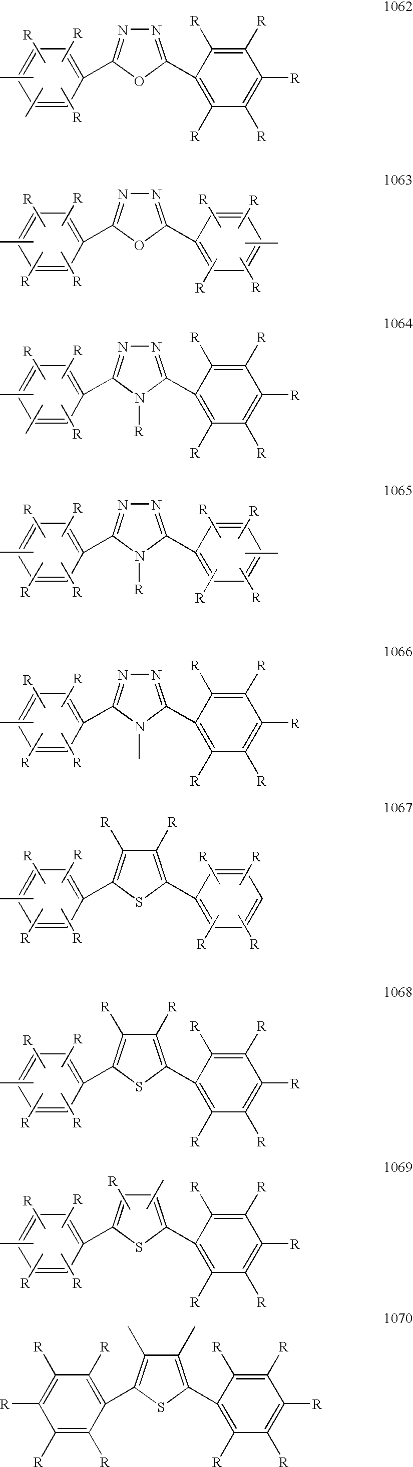

Here, as R, a hydrogen atom, alkyl group, alkoxy group, alkylthio group, alkylsilyl group, alkylamino group, hydroxyl group, amino group, carboxyl group, aldehyde group, cyano group, etc. are exemplified.

In the above formula, a plurality of Rs are contained in one group, but they may be the same or different from each other.

As for the alkyl group, alkoxy group, alkylthio group, alkylsilyl group, and alkylamino group, the above structures are exemplified

The divalent aromatic amine group means an atomic group in which two hydrogen atoms are removed from the aromatic ring of aromatic amine.

As the divalent aromatic amine group, for example, groups represented by formula-(7) are exemplified.

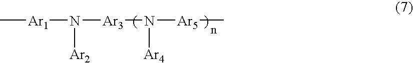

Wherein, Ar₁, Ar₃ and Ar₅ are each independently an arylene group or a divalent heterocyclic group. Ar₂ and Ar₄ are each independently an aryl group or a monovalent heterocyclic group. n represents an integer of 0-3. When n is two or more, a plurality of Ar₄ and Ar₅ may be the same or different.

Ar₁, Ar₂, Ar₃, Ar₄ and Ar₅ in the repeating unit represented by the above formula (7) may have a substituent, such as alkyl group, alkoxy group, alkylthio group, alkylsilyl group, alkylamino group, aryl group, aryloxy group, aryl silyl group, etc.

The definition and the concrete examples of alkyl group, alkoxy group, alkylthio group, alkylsilyl group, alkylamino group, and aryl group are the same with those definitions and the concrete examples in the above R.

The aryloxy group usually has about 6 to 60 carbon atoms, and specific examples thereof include phenoxy group, C₁-C₁₂ alkoxyphenoxy group, C₁-C₁₂ alkylphenoxy group, 1-naphtyloxy group, 2-naphtyloxy group, etc., and C₁-C₁₂ alkoxyphenoxy group, and C₁-C₁₂ alkylphenoxy group are preferable.

The aryl silyl group usually has about 6 to 60 carbon atoms, and specific examples thereof include phenyl silyl group, C₁-C₁₂ alkoxyphenyl silyl group, C₁-C₁₂ alkylphenyl silyl group, 1-naphtyl silyl group, 2-naphtyl silyl group, dimethylphenyl silyl group, etc., and C₁-C₁₂ alkoxyphenyl silyl group and C₁-C₁₂ alkylphenyl silyl group are preferable.

The aryl amino group usually has about 6 to 60 carbon atoms, and specific examples thereof include phenyl amino group, diphenyl amino group, C₁-C₁₂ alkoxyphenyl amino group, di(C₁-C₁₂ alkoxyphenyl)amino group, di(C₁-C₁₂ alkyl phenyl)amino group, 1-naphtyl amino group, 2-naphtyl amino group, etc., and C₁-C₁₂ alkylphenyl amino group and di(C₁-C₁₂ alkylphenyl)amino group are preferable.

The arylalkyl group usually has about 7 to 60 carbon atoms, and specific examples thereof include phenyl-C₁-C₁₂ alkyl group, C₁-C₁₂ alkoxyphenyl-C₁-C₁₂ alkyl group, C₁-C₁₂ alkylphenyl-C₁-C₁₂ alkyl group, 1-naphtyl-C₁-C₁₂ alkyl group, 2-naphtyl-C₁-C₁₂ alkyl group, etc., and C₁-C₁₂ alkoxyphenyl-C₁-C₁₂ alkyl group, and C₁-C₁₂ alkylphenyl-C₁-C₁₂ alkyl group are preferable.

The arylalkoxy group usually has about 7 to 60 carbon atoms, and specific examples thereof include phenyl-C₁-C₁₂ alkoxy group, C₁-C₁₂ alkoxyphenyl-C₁-C₁₂ alkoxy group, C₁-C₁₂ alkylphenyl-C₁-C₁₂ alkoxy group, 1-naphtyl-C₁-C₁₂ alkoxy group, 2-naphtyl-C₁-C₁₂ alkoxy group, etc., and C₁-C₁₂ alkoxyphenyl-C₁-C₁₂ alkoxy group, and C₁-C₁₂ alkylphenyl-C₁-C₁₂ alkoxy group are preferable.

The aryl alkylsilyl group usually has about 7 to 60 carbon atoms, and specific examples thereof include phenyl-C₁-C₁₂ alkylsilyl group, C₁-C₁₂ alkoxyphenyl-C₁-C₁₂ alkylsilyl group, C₁-C₁₂ alkylphenyl-C₁-C₁₂ alkylsilyl group, 1-naphtyl-C₁-C₁₂ alkylsilyl group, 2-naphtyl-C₁-C₁₂ alkylsilyl group, phenyl-C₁-C₁₂ alkyldimethyl silyl group, etc., and C₁-C₁₂ alkoxyphenyl-C₁-C₁₂ alkylsilyl group, and C₁-C₁₂ alkylphenyl-C₁-C₁₂ alkylsilyl group are preferable.

The arylalkylamino group usually has about 7 to 60 carbon atoms, and specific examples thereof include phenyl-C₁-C₁₂ alkylamino group, C₁-C₁₂ alkoxyphenyl-C₁-C₁₂ alkylamino group, C₁-C₁₂ alkylphenyl-C₁-C₁₂ alkylamino group, di(C₁-C₁₂ alkoxyphenyl-C₁-C₁₂ alkyl)amino group, di(C₁-C₁₂ alkylphenyl-C₁-C₁₂ alkyl)amino group, 1-naphtyl-C₁-C₁₂ alkylamino group, 2-naphtyl-C₁-C₁₂ alkylamino group, etc.; and C₁-C₁₂ alkylphenyl-C₁-C₁₂ alkylamino group, and diC₁-C₁₂ alkylphenyl-C₁-C₁₂ alkyl)amino group are preferable.

The arylalkenyl group usually has about 8 to 60 carbon atoms, and specific examples thereof include phenyl-C₂-C₁₂ alkenyl group, C₁-C₁₂ alkoxyphenyl-C₂-C₁₂ alkenyl group, C₁-C₁₂ alkylphenyl-C₂-C₁₂ alkenyl group, 1-naphtyl-C₂-C₁₂ alkenyl group, 2-naphtyl-C₂-C₁₂ alkenyl group, etc.; and C₁-C₁₂ alkoxyphenyl-C₂-C₁₂ alkenyl group, and C₁-C₁₂ alkylphenyl-C₂-C₁₂ alkenyl group are preferable.

The arylalkynyl group usually has about 7 to 60 carbon atoms, and specific examples thereof include phenyl-C₂-C₁₂ alkynyl group, C₁-C₁₂ alkoxyphenyl-C₁-C₁₂ alkynyl group, C₁-C₁₂ alkylphenyl-C₂-C₁₂ alkynyl group, 1-naphtyl-C₂-C₁₂ alkynyl group, 2-naphtyl-C₂-C₁₂ alkynyl group, etc.; and C₁-C₁₂ alkoxyphenyl-C₂-C₁₂ alkynyl group, and C₁-C₁₂ alkyl phenyl-C₂-C₁₂ alkynyl group are preferable.

Specific Examples of the repeating unit represented by the above formula (7), those represented by the below formulae are exemplified.

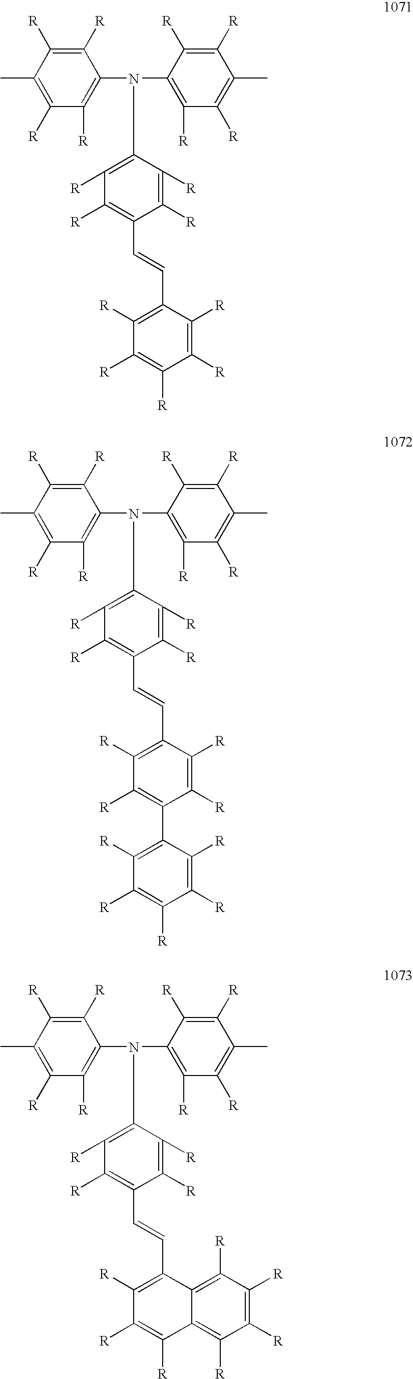

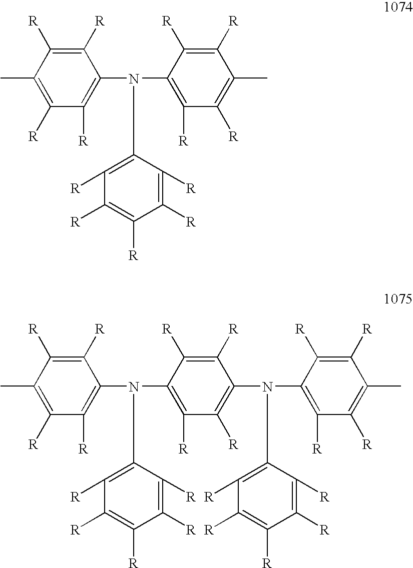

As R, a hydrogen atom, alkyl group, alkoxy group, alkylthio group, alkylsilyl group, alkylamino group, hydroxyl group, amino group, carboxyl group, aldehyde group, cyano group, etc. are exemplified; and alkyl group, alkoxy group, hydroxyl group, amino group, carboxyl group, and aldehyde group are preferable.

In the above formulae, a plurality of Rs are contained in one group, but they may be the same or different with each other.

The polymer of the invention has a repeating unit selected from the group consisting of arylene group, divalent heterocyclic group and divalent aromatic amine group.

In view of polymer characteristics such as solubility and fluorescence intensity, the polymer of the invention is preferably a polymer including one kind of arylene group as the repeating unit thereof, a copolymer including two kinds of arylene group as the repeating unit thereof, a copolymer including two kinds of divalent heterocyclic groups as the repeating unit thereof, a copolymer including two kinds of divalent aromatic amine groups as the repeating unit thereof, a copolymer including one kind of arylene group and one kind of divalent aromatic amine group as the repeating units thereof, a copolymer including one kind of arylene group and two kinds of divalent aromatic amine groups as the repeating unit thereof, a copolymer including one kind of divalent heterocyclic group and one kind of divalent aromatic amine group as the repeating unit thereof, and a copolymer including one kind of divalent heterocyclic group and two kinds of divalent aromatic amine groups as the repeating unit thereof; more preferably a polymer including one kind of arylene group as the repeating unit thereof, a copolymer including two kinds of arylene group as the repeating unit thereof, a copolymer including one kind of arylene group and two kinds of divalent aromatic amine groups as the repeating unit thereof, a copolymer including one kind of divalent heterocyclic group and one kind of divalent aromatic amine group as the repeating unit thereof, and a copolymer including one kind of divalent heterocyclic group and two kinds of divalent aromatic amine groups as the repeating units thereof; or still more preferably a copolymer including two kinds of arylene group as the repeating unit thereof, a copolymer including one kind of divalent heterocyclic group and one kind of divalent aromatic amine group as the repeating unit thereof, and a copolymer including one kind of divalent heterocyclic group and two kinds of divalent aromatic amine groups as the repeating unit thereof.

The polymer of the invention may, as long as its characteristics such as fluorescence property and charge tansporting property are not damaged, include repeating units other than the repeating unit selected from the group consisting of arylene group, divalent heterocyclic group and divalent aromatic amine group.

The polystyrene-reduced weight-average molecular weight of the polymer of the invention is usually 10³ to 10⁸, preferably, from a point of view about film forming property, 1×10⁴ to 5×10⁶, more preferably 1×10⁵ to 2×10⁶, still more preferably 2×10⁵ to 1×10⁶, or particularly preferably 3×10⁵ to 1×10⁶.

The good solvent for the polymer of the invention include chloroform, methylene chloride, dichloroethane, tetrahydrofuran, toluene, xylene, mesitylene, decalin and n-butylbenzene. The polymer may be dissolved in such solvent in an amount of 0.1% by weight or more depending on a structure or molecular weight thereof. The polymer of the invention is excellent in resistibility to electrolytic oxidation and/or reduction. The resistibility of the polymer to electrolytic reduction may, for example, be evaluated according to the molecular weight change thereof while a thin film thereof is retained with being used with negative voltage. The negative voltage may be used by a conventional way, as being mentioned later, such that an electrode coated with a polymer is employed as a working electrode in a Cyclic Voltammetry. A molecular weight change may be obtained by a gel permeation chromatography. Employing a ratio of molecular weight change for evaluating the molecular weight change is preferable to avoid effect caused by the extent of the average molecular weight of the polymer before voltage application; the ratio is defined by that the difference between average molecular weights of a polymer before and after voltage application is divided by the average molecular weight of the polymer before voltage application.

The resistibility of the polymer to electrolytic oxidation may, for example, be evaluated according to the molecular weight change thereof while a thin film thereof is retained with being used with positive voltage. The positive voltage may be used by a conventional way, as being mentioned later, in which an electrode coated with a polymer is employed as a working electrode in a Cyclic Voltammetry.

The polymer of the present invention can be produced by reacting one or more kinds of monomers selected from formula (3), (4) and (5), and a compound of formula (6).
Y₁—Ar₁—Y₂ (3)
Y₃—Ar₂—Y₄ (4)
Y₅—Ar₃—Y₆ (5)
E₁-Y₇ (6)

In the formula, Ar₁, Ar₂, and Ar₃ each independently represent an arylene group, divalent heterocyclic group, or divalent aromatic amine group. E₁ represents an unsaturated hydrocarbon group free of aromatic ring. Y₁, Y₂, Y₃, Y₄, Y₅, and Y₆ each independently represent a leaving group, and Y₇ represents a hydrogen atom or a leaving group. Here, two or more kinds of compounds of (6) also may be used.

Examples of the leaving groups include a halogen atom, alkylsulfonyloxy group, arylsulfonyloxy group, or —B(OR₁₁)₂ (wherein, R₁₁ is a hydrogen atom or alkyl group); a halogen atom, alkylsulfonyloxy group and arylsulfonyloxy group are preferable; and a halogen atom is further preferable.

As the halogen atom, chlorine atom, bromine atom, and iodine atom are exemplified, chlorine atom and bromine atom are preferable, and bromine atom is most preferable.

The alkylsulfonyloxy group may be substituted by fluorine atom, and trifluoromethane sulfonyloxy group is exemplified.

The arylsulfonyloxy group may be substituted by alkyl group, and phenylsulfonyloxy group, trisulfonyloxy group, etc. are exemplified.

In the group represented by —B(OR₁₁)₂, R₁₁ is a hydrogen atom or alkyl group. The alkyl group has usually about 1 to 20 carbon atoms, and includes a methyl group, ethyl group, propyl group, butyl group, hexyl group, octyl group, dodecyl group, etc. The alkyl groups themselves may form a ring bond.

Specifically, as the group represented by —B(OR₁₁)₂, following groups are exemplified.

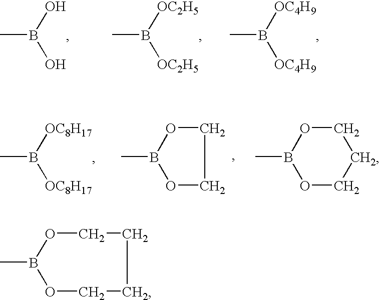

Following groups are preferable.

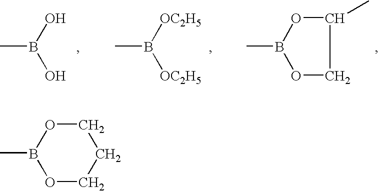

When polymerization is carried out by using compounds represented by formulas (3), (4), (5) and (6), if Y₇ being a leaving group, a compound represented by formula (6) is generally charged in an amount of 0.1 to 10% by mole based on the total amount of monomers represented by formulas (3), (4), (5) and (6), preferably 0.2 to 5% by mole, or more preferably 0.5 to 3% by mole. If Y₇ being hydrogen atom, the compound represented by formula (6) is generally charged in an amount of 10 to 1000% by mole based on the total amount of monomers represented by formulas (3), (4) and (5), preferably 50 to 500% by mole, or more preferably 100 to 300% by mole.

As the methods for producing the copolymer of the invention by using the foregoing monomers, exemplified are a method of polymerizztion according to Suzuki reaction (Chem. Rev. Vol. 95, Page 2457 (1995)), a polymerization by Grignard Reaction (KYORITSU SHUPPAN CO., LTD., Series of Functional Polymer Materials, Vol. 2, Synthesis and Reaction of Polymers (2), Pages 432-433), a method of polymerization according to Ymamoto polymerization reaction (Prog. Polym. Sci., Vol. 17, Page 1153-1205 (1992)), a polymerization by an oxidizing agent such as FeCl₃ and the like, and a method of oxidative polymerization by electrochemical way (MARUZEN Co,. Ltd. Course of Chemical Experiments (4^{th} version), Vol. 28 Pages 339-340).

The case employing Suzuki reaction is explained.

In this case, for example, with using monomers of which each of Y₁ and Y₂ is independently a group represented by —B(OR₁₁)₂ (wherein R₁₁ is hydrogen atom or alkyl group); each of Y₃ and Y₄ is independently halogen atom, alkylsulfonyloxy group or arylsulfonyloxy group; each of Y₅ and Y₆ is independently a group represented by —B(OR₁₁)₂ (wherein R₁₁ is hydrogen atom or alkyl group) or independently halogen atom, alkylsulfonyloxy group or arylsulfonyloxy group; Y₇ is a group represented by —B(OR₁₁)₂ (wherein R₁₁ is hydrogen atom or alkyl group); and Y₈ is halogen atom, alkylsulfonyloxy group or arylsulfonyloxy group; these monomers are subjected to reaction in the presence of Pd(0) catalyst to produce a polymer.

In this case, of among two or more kinds of monomers having two leaving groups which are subjected to the reaction, at least one of them is a monomer having two —B(OR₁₁)₂ (wherein R₁, is hydrogen atom or alkyl group,) and at least another one of them is a monomer having two halogen atoms, alkylsulfonyloxy groups or arylsulfonyloxy groups.

If Y₇ is a leaving group, reaction is generally carried out by subjecting monomers of (3) to (5) to reaction for about 1 to 100 hours, followed by the monomer (6) being added to the system to react for about 0.5 to 50 hours. If Y₇ is hydrogen atom, reaction is generally carried out by subjecting monomers of (3) to (6) to reaction for about 1 to 100 hours.

For the reaction, Pd(0) catalyst such as palladium[tetrakis(triphenylphosphine)] or palladium acetates is used with adding inorganic base such as potassium carbonate, sodium carbonate and barium hydroxide, organic base such as triethylamine, or inorganic salt such as cesium fluoride in an amount of equivalent to monomers or more, or preferably 1 to 10 equivalent. The inorganic salt may be used in aqueous state to carry out the reaction in a two phase system. Solvent includes N,N-dimethylformamide, toluene, dimethoxyethane and tetrahydrofuran. The temperature in a range from 50 to 160° C. is suitably used depending on the solvent employed. The temperature may be raised nearly up to the boiling point of the solvent employed, and then refluxed. The reaction time is about 1 to 200 hours.

The case employing Yamamoto reaction is explained.

In this case, for example, with using monomers of which each of Y₁, Y₂, Y₃, Y₄, Y₅ and Y₆ is independently halogen atom, alkylsulfonyloxy group or arylsulfonyloxy group, and Y₇ is hydrogen atom, halogen atom, alkylsulfonyloxy group or arylsulfonyloxy group, these monomers are subjected to reaction in the presence of Ni(0) catalyst to produce a polymer.

The reaction is generally carried out by mixing at least one selected from the compounds (3) to (5) and at least one selected from the compound (6).

Of the compound (6), preferable is a group of which Y₇ is hydrogen atom and E₁ contains two or more unsaturated bonds in formula (6), more preferable is cyclooctadiene as a monomer of formula (6), or further preferable is 1,5-cyclooctadiene.

1,5-cyclooctadiene is generally charged in an amount of 10 to 1000% by mole based on the total amount of monomers represented by formulas (3), (4) and (5), preferably 50 to 500% by mole, more preferably 100 to 300% by mole, still more preferably 250 to 300% by mole, or most preferably 260 to 275% by mole.

When using Ni(0) catalyst (zero-valent nickel complex) for reaction, the possible way for preparing nickel complex is using zero-valent nickel as itself or subjecting a salt of nickel to reaction in the presence of a reduction agent to generate zero-valent nickel in the reaction system.

The zero-valent nickel complex includes bis(1,5-cyclooctadiene)nickel(0), (ethylene)bis(triphenylphosphine)nickel(0), tetrakis(triphenylphosphine)nickel and the like; of these, bis(1,5-cyclooctadiene)nickel(0) is preferable due to its versatility and inexpensive cost.

Addition of a neutral ligand is preferable in view of enhancing yield.

The neutral ligand means a ligand not having anion or cation, and examples thereof include a nitrogen-containing ligand such as 2,2′-bipyridyl, 1,10-phenanthroline, methylenebisoxazoline and N,N′-tetramethylethylenediamine; and tertiary phosphine ligand such as triphenylphosphine, tritolylphosphine, tributylphosphine and triphenoxyphosphine; of these, preferable is the nitrogen-containing ligand due to its versatility and inexpensive cost, or more preferable is 2,2′-bipyridyl in view of high reactivity and high yield. Particularly preferable in view of enhancing polymer yield is the system of a bis(1,5-cyclooctadiene)nickel(0) containing system added with 2,2′-bipyridyl as a neutral ligand. Regarding a method of reacting a zero-valent nickel in the reaction system, the nickel salt includes nickel chloride, nickel acetate and the like. The reducing agent includes zinc, sodium hydride and hydrazine and derivatives thereof, and lithium aluminum hydride and the like; and additives such as ammonium iodide, lithium iodide, potassium iodide and the like may be used, if necessary.

The solvent for polymerization is not particularly limited as far as not inhibiting the polymerization, preferable is the one containing at least one kind of aromatic hydrocarbon solvents and/or ether solvents.

The aromatic hydrocarbon solvents include, for example, benzene, toluene, xylene, trimethylbenzene, tetramethylbenzene, butylbenzene, naphthalin and tetralin, or preferably toluene, xylene, tetralin and tetramethylbenzene. The ether solvents include, for example, diisopropyl ether, tetrahydrofuran, 1,4-dioxane, diphenyl ether, ethylene glycol dimethyl ether and tert-butylmethyl ether, or preferably tetrahydrofuran and 1,4-dioxane which are good solvent for polymer compounds. Of solvents, most preferable is tetrahydrofuran.

From a view point of improving polymerization property and solubility, a solvent mixture composed of the aromatic hydrocarbon solvent and/or the ether solvent being mixed with a solvent other than the aromatic hydrocarbon solvent and ether solvent may be used as far as not inhibiting the polymerization.

The reaction procedures may be carried out, for example, according to the method described in JP-A No. 2000-44544.

In the Yamamoto polymerization method, the polymerization reaction is generally carried out under an atmosphere of inert gas such as argon and nitrogen in a tetrahydrofuran solvent at 60° C. in the presence of a zero-valent nickel complex and a neutral ligand. The polymerization time is usually about 0.5 to 100 hours, or preferably 10 hours or less due to saving production cost; the polymerization temperature is usually about 0 to 200° C., or preferably 20 to 100° C. in view of high yield and reducing heating cost.

When a neutral ligand is used, the amount used is, from view points about reaction yields and production cost, preferably about 0.5 to 10 moles per 1 mole of the zero-valent nickel complex, more preferably 0.8 to 1.5 moles, or still more preferably 0.9 to 1.1 moles.

The amount of the zero-valent nickel complex used is not particularly limited as far as not disturbing polymerization reaction; however, if the amount being too low, the molecular weight tends to be decreased, and if the amount being too much, post treatment tends to become troublesome; therefore, the amount of 0.1 to 10 moles per 1 mole of monomer is preferable, 1 to 5 moles is more preferable, or 2 to 3.5 moles is still more preferable.

When the polymer of the invention is employed as a light emitting substance for polymer LEDs, since the purity thereof affects to the light emitting property, it is preferable that monomers provided for polymerization are purified in advance by the ways such as distillation, sublimation or recrystallization, and the polymer after being polymerized is subjected to purification treatments such as reprecipitation purification or fractionation with chromatography.

In the invention, for consideration regarding to characteristics required to device formation such as solubility to solvents, fluorescence intensity, life and brightness, two or more polymers of the invention may be appropriately combined for use.

The polymer of the invention is preferably used as a polymer composition which is blended with a polymer emitting fluorescence in the solid state and having a polystyrene-reduced number average molecular weight of 10³ to 10⁸. The polymer to be blended is not particularly limited as long as enhancing the characteristics required to device formation such as solubility to solvents, fluorescence intensity, life and brightness; specifically included are the polymers disclosed in JP-A No. 2001-247861, JP-A No. 2001-507511, JP-A No. 2001-504533, JP-A No. 2001-278958, JP-A No. 2001-261796, JP-A No. 2001-226469, JP-B No. 3161058 and the like, but not be limited thereto. The kind of the polymer compound includes, for example, polyarylene type polymers such as polyfluorene type polymers and polystilbene type polymers; polyarylenevinylene type polymers; polystilbenevinylene type polymers, polypyridinediyl type polymers and alkoxypolythiophene type polymers. Of these, preferable is polyarylene based copolymers (in which more preferable is polyfluorene type polymers or polystilbene type polymers), polyarylenevinylene based copolymers or polystilbenevinylene based copolymers. The amount of polymer compound to be blended to enhance the foregoing characteristics is preferably 5 to 60% by weight based on the total amount of the polymer composition, more preferably 20 to 50% by weight, or most preferably 25 to 35% by weight.

The polymer LED of the invention is characterized by having a light emitting layer disposed between an anode electrode and a cathode electrode, wherein the light emitting layer includes the copolymer or the polymer composition of the invention.

The polymer LED of the invention also includes a polymer light emitting device in which a layer having an electroconductive polymer is disposed between at least one electrode and the light emitting layer by being located adjacent to the electrode, and a polymer light emitting device in which an insulating layer having an average film thickness being 2 nm or less is disposed between at least one electrode and the light emitting layer by being located adjacent to the electrode.

As the polymer LED of the present invention, exemplified are: a polymer LED having an electron transporting layer between a cathode and a light emitting layer; a polymer LED having an hole transporting layer between an anode and a light emitting layer; and a polymer LED having an electron transporting layer between an cathode and a light emitting layer, and a hole transporting layer between an anode and a light emitting layer.

As the structure of polymer LED of the present invention, the following structures a) to d) are specifically exemplified.

a) anode/light emitting layer/cathode

b) anode/hole transporting layer/light emitting layer/cathode

c) anode/light emitting layer/electron transporting layer/cathode

d) anode/hole transporting layer/light emitting layer/electron transporting layer/cathode

(wherein, “/” indicates adjacent lamination of layers. Hereinafter, the same).

Herein, the light emitting layer is a layer having function to emit a light, the hole transporting layer is a layer having function to transport a hole, and the electron transporting layer is a layer having function to transport an electron. Herein, the electron transporting layer and the hole transporting layer are generically called a charge transporting layer.

The light emitting layer, hole transporting layer and electron transporting layer also may be used each independently in two or more layers.

Of charge transporting layers disposed adjacent to an electrode, that having function to improve charge injecting efficiency from the electrode and having effect to decrease driving voltage of an device are particularly called sometimes a charge injecting layer (hole injecting layer, electron injecting layer) in general.

For enhancing adherence with an electrode and improving charge injection from an electrode, the above-described charge injecting layer or insulation layer having a thickness of 2 nm or less may also be provided adjacent to an electrode, and further, for enhancing adherence of the interface, preventing mixing and the like, a thin buffer layer may also be inserted into the interface of a charge transporting layer and light emitting layer.

The order and number of layers laminated and the thickness of each layer can be appropriately used while considering light emitting efficiency and life of the device.

In the present invention, as the polymer LED having a charge injecting layer (electron injecting layer, hole injecting layer) provided, there are listed a polymer LED having a charge injecting layer provided adjacent to a cathode and a polymer LED having a charge injecting layer provided adjacent to an anode.

For example, the following structures e) to p) are specifically exemplified.

e) anode/charge injecting layer/light emitting layer/cathode

f) anode/light emitting layer/charge injecting layer/cathode

g) anode/charge injecting layer/light emitting layer/charge injecting layer/cathode

h) anode/charge injecting layer/hole transporting layer/light emitting layer/cathode

i) anode/hole transporting layer/light emitting layer/charge injecting layer/cathode

j) anode/charge injecting layer/hole transporting layer/light emitting layer/charge injecting layer/cathode

k) anode/charge injecting layer/light emitting layer/electron transporting layer/cathode

l) anode/light emitting layer/electron transporting layer/charge injecting layer/cathode

m) anode/charge injecting layer/light emitting layer/electron transporting layer/charge injecting layer/cathode

n) anode/charge injecting layer/hole transporting layer/light emitting layer/electron transporting layer/cathode

o) anode/hole transporting layer/light emitting layer/electron transporting layer/charge injecting layer/cathode

p) anode/charge injecting layer/hole transporting layer/light emitting layer/electron transporting layer/charge injecting layer/cathode

As the specific examples of the charge injecting layer, there are exemplified layers containing an conducting polymer, layers which are disposed between an anode and a hole transporting layer and contain a material having an ionization potential between the ionization potential of an anode material and the ionization potential of a hole transporting material contained in the hole transporting layer, layers which are disposed between a cathode and an electron transporting layer and contain a material having an electron affinity between the electron affinity of a cathode material and the electron affinity of an electron transporting material contained in the electron transporting layer, and the like.

When the above-described charge injecting layer is a layer containing an conducting polymer, the electric conductivity of the conducting polymer is preferably 10⁻⁵ S/cm or more and 10³ S/cm or less, and for decreasing the leak current between light emitting pixels, more preferably 10⁻⁵ S/cm or more and 10² S/cm or less, further preferably 10⁻⁵ S/cm or more and 10¹ S/cm or less.

Usually, to provide an electric conductivity of the conducting polymer of 10⁻⁵ S/cm or more and 10³ S/cm or less, a suitable amount of ions are doped into the conducting polymer.

Regarding the kind of an ion doped, an anion is used in a hole injecting layer and a cation is used in an electron injecting layer. As examples of the anion, a polystyrene sulfonate ion, alkylbenzene sulfonate ion, camphor sulfonate ion and the like are exemplified, and as examples of the cation, a lithium ion, sodium ion, potassium ion, tetrabutyl ammonium ion and the like are exemplified.

The thickness of the charge injecting layer is for example, from 1 nm to 100 nm, preferably from 2 nm to 50 nm.

Materials used in the charge injecting layer may properly be selected in view of relation with the materials of electrode and adjacent layers, and there are exemplified conducting polymers such as polyaniline and derivatives thereof, polythiophene and derivatives thereof, polypyrrole and derivatives thereof, poly(phenylene vinylene) and derivatives thereof, poly(thienylene vinylene) and derivatives thereof, polyquinoline and derivatives thereof, polyquinoxaline and derivatives thereof, polymers containing aromatic amine structures in the main chain or the side chain, and the like, and metal phthalocyanine (copper phthalocyanine and the like), carbon and the like.

The insulation layer having a thickness of 2 nm or less has function to make charge injection easy. As the material of the above-described insulation layer, metal fluoride, metal oxide, organic insulation materials and the like are listed. As the polymer LED having an insulation layer having a thickness of 2 nm or less, there are listed polymer LEDs having an insulation layer having a thickness of 2 nm or less provided adjacent to a cathode, and polymer LEDs having an insulation layer having a thickness of 2 nm or less provided adjacent to an anode.

Specifically, there are listed the following structures q) to ab) for example.

q) anode/insulation layer having a thickness of 2 nm or less/light emitting layer/cathode

r) anode/light emitting layer/insulation layer having a thickness of 2 nm or less/cathode

s) anode/insulation layer having a thickness of 2 nm or less/light emitting layer/insulation layer having a thickness of 2 nm or less/cathode

t) anode/insulation layer having a thickness of 2 nm or less/hole transporting layer/light emitting layer/cathode

u) anode/hole transporting layer/light emitting layer/insulation layer having a thickness of 2 nm or less/cathode

v) anode/insulation layer having a thickness of 2 nm or less/hole transporting layer/light emitting layer/insulation layer having a thickness of 2 nm or less/cathode

w) anode/insulation layer having a thickness of 2 nm or less/light emitting layer/electron transporting layer/cathode

x) anode/light emitting layer/electron transporting layer/insulation layer having a thickness of 2 nm or less/cathode

y) anode/insulation layer having a thickness of 2 nm or less/light emitting layer/electron transporting layer/insulation layer having a thickness of 2 nm or less/cathode

z) anode/insulation layer having a thickness of 2 nm or less/hole transporting layer/light emitting layer/electron transporting layer/cathode

aa) anode/hole transporting layer/light emitting layer/electron transporting layer/insulation layer having a thickness of 2 nm or less/cathode

ab) anode/insulation layer having a thickness of 2 nm or less/hole transporting layer/light emitting layer/electron transporting layer/insulation layer having a thickness of 2 nm or less/cathode

In the polymer LED of the present invention, light emitting materials other than the above described polymer or polymer composition can also be mixed in a light emitting layer. Further, in the polymer LED of the present invention, the light emitting layer containing light emitting materials other than the above polymeric fluorescent substance may also be laminated with a light emitting layer containing the above polymer.

As the light emitting material, known materials can be used. In a compound having lower molecular weight, there can be used, for example, naphthalene derivatives, anthracene or derivatives thereof, perylene or derivatives thereof; dyes such as polymethine dyes, xanthene dyes, coumarine dyes, cyanine dyes; metal complexes of 8-hydroxyquinoline or derivatives thereof, aromatic amine, tetraphenylcyclopentane or derivatives thereof, or tetraphenylbutadiene or derivatives thereof, and the like.

Specifically, there can be used known compounds such as those described in JP-A Nos. 57-51781, 59-195393 and the like, for example.

Although the film molding of a light emitting layer is not restricted, and for example, includes a method by film molding from solution, for example.

As the film forming method from a solution, there can be used coating methods such as a spin coating method, casting method, micro gravure coating method, gravure coating method, bar coating method, roll coating method, wire bar coating method, dip coating method, spray coating method, screen printing method, flexo printing method, offset printing method, inkjet printing method and the like.

As the solvent used for film forming from a solution, toluene, xylene, chloroform, and tetrahydrofuran are exemplified.

Regarding the thickness of the light emitting layer, the optimum value differs depending on material used, and may properly be selected so that the driving voltage and the light emitting efficiency become optimum values, and for example, it is from 1 nm to 1 μm, preferably from 2 nm to 500 nm, further preferably from 5 nm to 200 nm.

When the polymer LED of the present invention has a hole transporting layer, as the hole transporting materials used, there are exemplified polyvinylcarbazole or derivatives thereof, polysilane or derivatives thereof, polysiloxane derivatives having an aromatic amine in the side chain or the main chain, pyrazoline derivatives, arylamine derivatives, stilbene derivatives, triphenyldiamine derivatives, polyaniline or derivatives thereof, polythiophene or derivatives thereof, polypyrrole or derivatives thereof, poly(p-phenylenevinylene) or derivatives thereof, poly(2,5-thienylenevinylene) or derivatives thereof, or the like.

Specific examples of the hole transporting material include those described in JP-A Nos. 63-70257, 63-175860, 2-135359, 2-135361, 2-209988, 3-37992 and 3-152184.

Among them, as the hole transporting materials used in the hole transporting layer, preferable are polymer hole transporting materials such as polyvinylcarbazole or derivatives thereof, polysilane or derivatives thereof, polysiloxane derivatives having an aromatic amine compound group in the side chain or the main chain, polyaniline or derivatives thereof, polythiophene or derivatives thereof, poly(p-phenylenevinylene) or derivatives thereof, poly(2,5-thienylenevinylene) or derivatives thereof, or the like, and further preferable are polyvinylcarbazole or derivatives thereof, polysilane or derivatives thereof and polysiloxane derivatives having an aromatic amine compound group in the side chain or the main chain. In the case of a hole transporting material having lower molecular weight, it is preferably dispersed in a polymer binder for use.

Polyvinylcarbazole or derivatives thereof are obtained, for example, by cation polymerization or radical polymerization from a vinyl monomer.

As the polysilane or derivatives thereof, there are exemplified compounds described in Chem. Rev., 89, 1359 (1989) and GB 2300196 published specification, and the like. For synthesis, methods described in them can be used, and a Kipping method can be suitably used particularly.

As the polysiloxane or derivatives thereof, those having the structure of the above-described hole transporting material having lower molecular weight in the side chain or main chain, since the siloxane skeleton structure has poor hole transporting property. Particularly, there are exemplified those having an aromatic amine having hole transporting property in the side chain or main chain.

The method for forming a hole transporting layer is not restricted, and in the case of a hole transporting layer having lower molecular weight, a method in which the layer is formed from a mixed solution with a polymer binder is exemplified. In the case of a polymer hole transporting material, a method in which the layer is formed from a solution is exemplified.

The solvent used for the film forming from a solution is not particularly restricted providing it can dissolve a hole transporting material. As the solvent, there are exemplified chlorine solvents such as chloroform, methylene chloride, dichloroethane and the like, ether solvents such as tetrahydrofuran and the like, aromatic hydrocarbon solvents such as toluene, xylene and the like, ketone solvents such as acetone, methyl ethyl ketone and the like, and ester solvents such as ethyl acetate, butyl acetate, ethylcellosolve acetate and the like.

As the film forming method from a solution, there can be used coating methods such as a spin coating method, casting method, micro gravure coating method, gravure coating method, bar coating method, roll coating method, wire bar coating method, dip coating method, spray coating method, screen printing method, flexo printing method, offset printing method, inkjet printing method and the like, from a solution.

The polymer binder mixed is preferably that does not disturb charge transport extremely, and that does not have strong absorption of a visible light is suitably used. As such polymer binder, polycarbonate, polyacrylate, poly(methyl acrylate), poly(methyl methacrylate), polystyrene, poly(vinyl chloride), polysiloxane and the like are exemplified.

Regarding the thickness of the hole transporting layer, the optimum value differs depending on material used, and may properly be selected so that the driving voltage and the light emitting efficiency become optimum values, and at least a thickness at which no pin hole is produced is necessary, and too large thickness is not preferable since the driving voltage of the device increases. Therefore, the thickness of the hole transporting layer is, for example, from 1 nm to 1 μm, preferably from 2 nm to 500 nm, further preferably from 5 nm to 200 nm.

When the polymer LED of the present invention has an electron transporting layer, known compounds are used as the electron transporting materials, and there are exemplified oxadiazole derivatives, anthraquinonedimethane or derivatives thereof, benzoquinone or derivatives thereof, naphthoquinone or derivatives thereof, anthraquinone or derivatives thereof, tetracyanoanthraquinodimethane or derivatives thereof, fluorenone derivatives, diphenyldicyanoethylene or derivatives thereof, diphenoquinone derivatives, or metal complexes of 8-hydroxyquinoline or derivatives thereof, polyquinoline and derivatives thereof, polyquinoxaline and derivatives thereof, polyfluorene or derivatives thereof, and the like.

Specifically, there are exemplified those described in JP-A Nos. 63-70257, 63-175860, 2-135359, 2-135361, 2-209988, 3-37992 and 3-152184.

Among them, oxadiazole derivatives, benzoquinone or derivatives thereof, anthraquinone or derivatives thereof, or metal complexes of 8-hydroxyquinoline or derivatives thereof, polyquinoline and derivatives thereof, polyquinoxaline and derivatives thereof, polyfluorene or derivatives thereof are preferable, and 2-(4-biphenyl)-5-(4-t-butylphenyl)-1,3,4-oxadiazole, benzoquinone, anthraquinone, tris(8-quinolinol)aluminum and polyquinoline are further preferable.

The method for forming the electron transporting layer is not particularly restricted, and in the case of an electron transporting material having lower molecular weight, a vapor deposition method from a powder, or a method of film-forming from a solution or melted state is exemplified, and in the case of a polymer electron transporting material, a method of film-forming from a solution or melted state is exemplified, respectively.

The solvent used in the film-forming from a solution is not particularly restricted provided it can dissolve electron transporting materials and/or polymer binders. As the solvent, there are exemplified chlorine solvents such as chloroform, methylene chloride, dichloroethane and the like, ether solvents such as tetrahydrofuran and the like, aromatic hydrocarbon solvents such as toluene, xylene and the like, ketone solvents such as acetone, methyl ethyl ketone and the like, and ester solvents such as ethyl acetate, butyl acetate, ethylcellosolve acetate and the like.

As the film-forming method from a solution or melted state, there can be used coating methods such as a spin coating method, casting method, micro gravure coating method, gravure coating method, bar coating method, roll coating method, wire bar coating method, dip coating method, spray coating method, screen printing method, flexo printing method, offset printing method, inkjet printing method and the like.

The polymer binder to be mixed is preferably that which does not extremely disturb a charge transport property, and that does not have strong absorption of a visible light is suitably used. As such polymer binder, poly(N-vinylcarbazole), polyaniline or derivatives thereof, polythiophene or derivatives thereof, poly(p-phenylene vinylene) or derivatives thereof, poly(2,5-thienylene vinylene) or derivatives thereof, polycarbonate, polyacrylate, poly(methyl acrylate), poly(methyl methacrylate), polystyrene, poly(vinyl chloride), polysiloxane and the like are exemplified.

Regarding the thickness of the electron transporting layer, the optimum value differs depending on material used, and may properly be selected so that the driving voltage and the light emitting efficiency become optimum values, and at least a thickness at which no pin hole is produced is necessary, and too large thickness is not preferable since the driving voltage of the device increases. Therefore, the thickness of the electron transporting layer is, for example, from 1 nm to 1 μm, preferably from 2 nm to 500 nm, further preferably from 5 nm to 200 nm.

The substrate forming the polymer LED of the present invention may preferably be that does not change in forming an electrode and layers of organic materials, and there are exemplified glass, plastics, polymer film, silicon substrates and the like. In the case of a opaque substrate, it is preferable that the opposite electrode is transparent or semitransparent.

Usuallu, at least one of the electrodes consisting of an anode and a cathode, is transparent or semitransparent. It is preferable that the anode is transparent or semitransparent. As the material of this anode, electron conductive metal oxide films, semitransparent metal thin films and the like are used. Specifically, there are used indium oxide, zinc oxide, tin oxide, and films (NESA and the like) fabricated by using an electron conductive glass composed of indium/tin/oxide (ITO), indium/zinc/oxide and the like, which are metal oxide complexes, and gold, platinum, silver, copper and the like are used, and among them, ITO, indium/zinc/oxide, tin oxide are preferable. As the fabricating method, a vacuum vapor deposition method, sputtering method, ion plating method, plating method and the like are used. As the anode, there may also be used organic transparent conducting films such as polyaniline or derivatives thereof, polythiophene or derivatives thereof and the like.

The thickness of the anode can be appropriately selected while considering transmission of a light and electric conductivity, and for example, from 10 nm to 10 μm, preferably from 20 nm to 1 μm, further preferably from 50 nm to 500 nm.

Further, for easy charge injection, there may be provided on the anode a layer comprising a phthalocyanine derivative conducting polymers, carbon and the like, or a layer having an average film thickness of 2 nm or less comprising a metal oxide, metal fluoride, organic insulating material and the like.

As the material of a cathode used in the polymer LED of the present invention, that having lower work function is preferable. For example, there are used metals such as lithium, sodium, potassium, rubidium, cesium, beryllium, magnesium, calcium, strontium, barium, aluminum, scandium, vanadium, zinc, yttrium, indium, cerium, samarium, europium, terbium, ytterbium and the like, or alloys comprising two of more of them, or alloys comprising one or more of them with one or more of gold, silver, platinum, copper, manganese, titanium, cobalt, nickel, tungsten and tin, graphite or graphite intercalation compounds and the like. Examples of alloys include a magnesium-silver alloy, magnesium-indium alloy, magnesium-aluminum alloy, indium-silver alloy, lithium-aluminum alloy, lithium-magnesium alloy, lithium-indium alloy, calcium-aluminum alloy and the like. The cathode may be formed into a laminated structure of two or more layers.

The thickness of the cathode can be appropriately selected while considering transmission of a light and electric conductivity, and for example, from 10 nm to 10 μm, preferably from 20 nm to 1 μm, further preferably from 50 nm to 500 nm.

As the method for fabricating a cathode, there are used a vacuum vapor deposition method, sputtering method, lamination method in which a metal thin film is adhered under heat and pressure, and the like. Further, there may also be provided, between a cathode and an organic layer, a layer comprising an conducting polymer, or a layer having an average film thickness of 2 nm or less comprising a metal oxide, metal fluoride, organic insulation material and the like, and after fabrication of the cathode, a protective layer may also be provided which protects the polymer LED. For stable use of the polymer LED for a long period of time, it is preferable to provide a protective layer and/or protective cover for protection of the device in order to prevent it from outside damage.

As the protective layer, there can be used a polymeric compound, metal oxide, metal fluoride, metal borate and the like. As the protective cover, there can be used a glass plate, a plastic plate the surface of which has been subjected to lower-water-permeation treatment, and the like, and there is suitably used a method in which the cover is pasted with an device substrate by a thermosetting resin or light-curing resin for sealing. If space is maintained using a spacer, it is easy to prevent an device from being injured. If an inner gas such as nitrogen and argon is sealed in this space, it is possible to prevent oxidation of a cathode, and further, by placing a desiccant such as barium oxide and the like in the above-described space, it is easy to suppress the damage of an device by moisture adhered in the production process. Among them, any one means or more are preferably adopted.

The polymer LED of the present invention can be used for a flat light source, a segment display, a dot matrix display, and a liquid crystal display as a back light, etc.

For obtaining light emission in plane form using the polymer LED of the present invention, an anode and a cathode in the plane form may properly be placed so that they are laminated each other. Further, for obtaining light emission in pattern form, there is a method in which a mask with a window in pattern form is placed on the above-described plane light emitting device, a method in which an organic layer in non-light emission part is formed to obtain extremely large thickness providing substantial non-light emission, and a method in which any one of an anode or a cathode, or both of them are formed in the pattern. By forming a pattern by any of these methods and by placing some electrodes so that independent on/off is possible, there is obtained a display device of segment type which can display digits, letters, simple marks and the like. Further, for forming a dot matrix device, it may be advantageous that anodes and cathodes are made in the form of stripes and placed so that they cross at right angles. By a method in which a plurality of kinds of polymeric compounds emitting different colors of lights are placed separately or a method in which a color filter or luminescence converting filter is used, area color displays and multi color displays are obtained. A dot matrix display can be driven by passive driving, or by active driving combined with TFT and the like. These display devices can be used as a display of a computer, television, portable terminal, portable telephone, car navigation, view finder of a video camera, and the like.

Further, the above-described light emitting device in plane form is a thin self-light-emitting one, and can be suitably used as a flat light source for back-light of a liquid crystal display, or as a flat light source for illumination. Further, if a flexible plate is used, it can also be used as a curved light source or a display.

The invention is explained in more detail hereinafter by referring to examples, but not be limited thereto.

The polystyrene-reduced number average molecular weight and weight average molecular weight were obtained by a gel permeation chromatography (GPC). Chloroform was used as a solvent, and a differential refractive index detector was applied for detection.

The structure of the polymer ends was analyzed by a mass spectrometry method using a time-of-flight mass spectrometry equipped with matrix assisted laser desorption ionization device (referred to as MALDI-TOFMS hereinafter) and a solution high-resolution nuclear magnetic resonance method (being referred to as high-resolution NMR method hereinafter) according to the following procedures; a matrix solution for MALDI and a tetrahydrofuran solution of a polymer was mixed in a ratio of 5:1 by volume, 1 μl of the mixture was put on a target plate, and then being inserted into the MALDI-TOFMS Reflex III type manufactured by BRUKER DALLTONICS to be measured in positive ionization mode. The mass numbers resulting from the measurement were analyzed to calculating out a exact mass number of the individual polymer, followed by the polymerization degree and the functional group coupling with terminal ends were specified.

The presence of unsaturated bond excluding aromatic ring was further evaluated according to NMR spectrum of a polymer obtained by subjecting the polymer dissolved in deuterium-labeled chloroform to measurement by a high-resolution NMR, the evaluation was performed according to the presence of peaks appeared in the chemical shift ranging from 5.5 to 6.0 ppm under TMS being set at 0 ppm.

The test for resistibility to electrolytic reduction was carried out by following procedures; 1% toluene solution of a polymer was coated by spinning on a gold electrode evaporated on the glass plate, followed by being dried under ambient atmosphere and then further being dried at 60° C. under a reduced pressure to prepare a working electrode; the prepared working electrode, a platinum electrode as counter electrode, a non-aqueous Ag/Ag⁺ reference electrode as reference electrode and a 0.1 M dehydrated acetonitrile solution of tetra-n-butylammonium tetrafluoroborate as electrolyte were used for the test; and the working electrode, the counter electrode and the reference electrode were immersed into the electrolyte in a gloved box, each of electrode was respectively connected to an electrochemical-analyzer model 600A manufactured by ALS Company, and then the working electrode was retained for 90 minutes by being applied with the voltage of −2.6 V. After the voltage was return to 0 V, the surface of working electrode was washed with dehydrated acetonitrile, followed by the polymer on the working electrode surface being dissolved with toluene to obtain a toluene solution of the polymer. This toluene solution and a toluene solution of the polymer before voltage application were independently analyzed by GPC, followed by a molecular weight at the peak position appeared in the respective GPC chromatogram being set for the polystyrene-reduced molecular weight of the polymer (being referred to as Mₚ hereinafter). The detection of GPC was carried out by an ultra-violet detector. Then Mₚ values respectively measured were applied to obtain a scale to evaluate resistibility to electrolytic reduction, the scaling value was calculated as follows; an amount of the difference between Mₚ after voltage application and Mₚ before voltage application is divided by Mₚ before voltage application (this value being referred to as ΔMₚ/Mₚ hereinafter). If ΔMₚ/Mₚ shows negative value, this means average molecular weight being decreased by the electrolytic reduction treatment; consequently resistibility to electrolytic reduction is low. On the other hand, if ΔMₚ/Mₚ shows 0 or positive value, this means average molecular weight being unchanged or increased by the electrolytic reduction treatment; consequently resistibility to electrolytic reduction is high.

### EXAMPLE 1

<Synthesis of Polymer 1>

2,7-dibromo-9,9-dioctylfluorene (450 mg, 0.82 mmol), 2,7-dibromo-9,9-diisopentylfluorene (130 mg, 0.27 mmol), 1,5-cyclooctadiene (310 mg, 2.9 mmol) and 2,2′-bipyridyl (320 mg, 2.1 mmol) were dissolved in 28 mL of dehydrated tetrahydrofuran, followed by the solution being bubbled with nitrogen to replace inside of the system with nitrogen. Bis(1,5-cyclooctadiene)nickel (0){Ni(COD)₂}(580 mg, 2.1 mmol) was added into the solution under nitrogen atmosphere, followed by being heated up to 60° C. and reacted for 3 hours with being stirred. After the reaction finished, the reactant was cooled down to the room temperature (about 25° C.), followed by being dropped into a mixture of 10 mL of 25% aqueous ammonia/120 mL of methanol/50 mL of ion-exchange water and being stirred for 1 hour to precipitate, and then the precipitate was filtered, followed by being dried for 2 hours under reduced pressure and then being dissolved in 30 mL of toluene. The toluene solution was added with 30 mL of 1 N hydrochloric acid, followed by being stirred for 1 hour, the organic layer obtained after the aqueous layer being removed from the solution was added with 30 mL of 4% aqueous ammonia, followed by being stirred for 1 hour and then the aqueous layer being removed. The organic layer was dropped into 200 mL of methanol, followed by being stirred for 1 hour to precipitate, and then the precipitate was filtered, followed by being dried for 2 hours under reduced pressure and then being dissolved in 30 mL of toluene. The toluene solution was purified by passing through a column packed with alumina (amount of alumina being 20 g), then the recovered toluene solution was dropped into 150 mL of methanol, followed by being stirred for 1 hour to precipitate, and then the precipitate was filtered, followed by being dried for 2 hours under reduced pressure. The amount of Polymer 1 obtained was 250 mg. The ratio of the repeating unit of formula (8) to that of formula (9) in Polymer 1 was 75:25 according to the ratio of monomers charged for reaction.

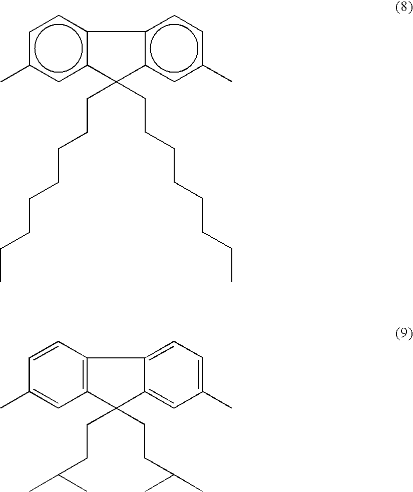

The polystyrene-reduced number average molecular weight of Polymer 1 was 1.5×10⁴, and the polystyrene-reduced weight average molecular weight thereof was 3.2×10⁴.

<Analysis of Terminal Ends of Polymer 1>

Resulting from the analysis of MALDI-TOFMS spectrum of Polymer 1, molecules having mass number exhibited in Table 1 were observed; detected were a peak having mass number greater in the extent of 1,5-cyclooctadiene's molecular weight (108)-2 in comparison with the mass number having hydrogen-substituted terminal end groups at the both terminal ends, and a molecule having mass number greater in the extent of twice of 1,5-cyclooctadiene's molecular weight (216)-4 in comparison with the foregoing way. According to this result, analyzed were two kinds of polymer; the polymer chain of which one end was coupled with a group derived from 1,5-cyclooctadiene, i.e. C₈H₁₁— group, and the other end was hydrogen-substituted terminal end group, and the polymer chain of which both ends were coupled with C₈H₁₁— group. The C₈H₁₁— group is a group derived from formula (2) by setting i=8 and j=2. In addition, since the presence of a peak was observed in the range from 5.5 to 6.0 ppm in high-resolution NMR spectrum of Polymer 1, it is found that C₈H₁₁— group existing at terminal end of Polymer 1 had an unsaturated bond excluding aromatic ring.

TABLE 1
Results of MALDI-TOFMS on Polymer 1

| | | | Terminal |
|---|---|---|---|
| Mass | | | End |
| Number | M | N | Group |
| 1295.02 | 2 | 1 | E-, E- |
| 1379.11 | 3 | 0 | E-, E- |
| 1515.14 | 1 | 3 | E-, E- |
| 1577.25 | 3 | 1 | H-, E- |
| 1599.24 | 2 | 2 | E-, E- |
| 1661.35 | 4 | 0 | H-, E- |
| 1683.33 | 3 | 1 | E-, E- |
| 1767.42 | 4 | 0 | E-, E- |
| 1881.47 | 3 | 2 | H-, E- |
| 1903.46 | 2 | 3 | E-, E- |
| 1965.57 | 4 | 1 | H-, E- |
| 1987.55 | 3 | 2 | E-, E- |
| 2049.66 | 5 | 0 | H-, E- |
| 2071.64 | 4 | 1 | E-, E- |
| 2155.74 | 5 | 0 | E-, E- |
| 2207.67 | 2 | 4 | E-, E- |
| 2269.78 | 4 | 2 | H-, E- |
| 2291.77 | 3 | 3 | E-, E- |
| 2353.88 | 5 | 1 | H-, E- |
| 2375.86 | 4 | 2 | E-, E- |
| 2437.97 | 6 | 0 | H-, E- |
| 2459.96 | 5 | 1 | E-, E- |
| 2544.05 | 6 | 0 | E-, E- |
| 2574.00 | 4 | 3 | H-, E- |
| 2595.99 | 3 | 4 | E-, E- |
| 2658.10 | 5 | 2 | H-, E- |
| 2680.08 | 4 | 3 | E-, E- |
| 2742.19 | 6 | 1 | H-, E- |
| 2764.18 | 5 | 2 | E-, E- |
| 2826.28 | 7 | 0 | H-, E- |
| 2848.27 | 6 | 1 | E-, E- |
| 2932.36 | 7 | 0 | E-, E- |
| 2962.32 | 5 | 3 | H-, E- |
| 2984.30 | 4 | 4 | E-, E- |
| 3046.41 | 6 | 2 | H-, E- |
| 3068.39 | 5 | 3 | E-, E- |
| 3130.50 | 7 | 1 | H-, E- |
| 3152.49 | 6 | 2 | E-, E- |
| 3214.60 | 8 | 0 | H-, E- |
| 3236.58 | 7 | 1 | E-, E- |
| 3320.68 | 8 | 0 | E-, E- |
| 3350.63 | 6 | 3 | H-, E- |
| 3372.61 | 5 | 4 | E-, E- |
| 3434.72 | 7 | 2 | H-, E- |
| 3456.71 | 6 | 3 | E-, E- |
| 3518.82 | 8 | 1 | H-, E- |
| 3540.80 | 7 | 2 | E-, E- |
| 3602.91 | 9 | 0 | H-, E- |
| 3624.90 | 8 | 1 | E-, E- |
| 3708.99 | 9 | 0 | E-, E- |
| 3738.94 | 7 | 3 | H-, E- |
| 3760.93 | 6 | 4 | E-, E- |
| 3823.04 | 8 | 2 | H-, E- |
| 3845.02 | 7 | 3 | E-, E- |
| 3907.13 | 9 | 1 | H-, E- |
| 3929.11 | 8 | 2 | E-, E- |
| 4013.21 | 9 | 1 | E-, E- |
| 4097.30 | 10 | 0 | E-, E- |

Since each atom has some kinds of stable isotopes, a compound is observed in the MALDI-TOFMS spectrum as a set of plural peaks split depending on the presence probability of the stable isotopes. Listed in Table 1 is a typical mass number peak of plural peaks observed in the MALDI-TOFMS spectrum, the typical mass number peak means a peak solely composed of an atom having smallest mass number selected from the stable isotopes thereof, that is, ¹H in hydrogen, ¹²C in carbon atom, ¹⁴N in nitrogen and ¹⁶O in oxygen. A sign of M in Table represents the number of 9,9-dioctylfluorene repeating unit composing the polymer, and a sign of N represents the number of 9,9-diisopentylfluorene repeating unit composing the polymer. A sign of ┌H⁻┘ described in the terminal end group column shows a terminal end group being the foregoing hydrogen-substituted terminal end group, and a sign of ┌E⁻┘ shows a terminal end group of molecular chain being C₈H₁₁— group. Judging from the observed peaks, it is clear that no repeating unit other than 9,9-dioctylfluorene repeating unit and 9,9-diisopentylfluorene repeating unit are contained in Polymer 1. Consequently, the C₈H₁₁— group as the terminal end group of the molecular chain directly couples with 9,9-dioctylfluorene repeating unit or 9,9-diisopentylfluorene repeating unit.

<Resistibility Test to Electrolytic Reduction of Polymer 1>

Since ΔMₚ/Mₚ of Polymer 1 obtained by the foregoing method was a positive value of +0.026, the resistibility to electrolytic reduction of Polymer 1 was excellent.

### SYNTHESIS EXAMPLE 1

<Synthesis of Polymer 2>

Under nitrogen atmosphere, 9,9-dioctylfluorene-2,7-bis(ethyleneboronate) (305 mg, 0.575 mmol), 2,7-dibromo-9,9-diisopentylfluorene (309 mg, 0.564 mmol), and aliquat 336 (16 mg, 0.040 mmol) were dissolved in toluene (4.3 g), followed by the solution being added with 1.0 g of aqueous potassium carbonate (249 mg, 1.80 mmol). The solution was further added with tetrakis(triphenylphosphine)palladium (4 mg, 0.0036 mmol), followed by being heated up to 110° C. and reacted for 20 hours with being stirred. After the reaction finished, the reactant was added with a solution of bromobenzene (14 mg, 0.0892 mmol) dissolved in 0.1 mL of toluene, followed by being stirred at 110° C. for 5 hours. After the reactant was cooled down to 50° C., the organic layer thereof was dropped into a mixture of methanol/water (1/1) and being stirred for 1 hour to precipitate. The precipitate was filtered, followed by being washed with methanol and ion-exchange water and then being dried under reduced pressure. This dried substance was dissolved in 50 mL of toluene, followed by the toluene solution being purified by passing through a column packed with silica (silica volume being 15 mL). The purified solution was dropped into methanol, followed by being stirred for 1 hour to precipitate, and then the precipitate was filtered, followed by being dried under reduced pressure to obtain Polymer 2. The amount of Polymer 2 obtained was 370 mg.

The polystyrene-reduced number average molecular weight of Polymer 2 was 2.8×10⁴, and the polystyrene-reduced weight average molecular weight thereof was 7.9×10⁴.

### COMPARATIVE EXAMPLE 1

<Analysis of Terminal Ends of Polymer 2>

Resulting from the analysis of MALDI-TOFMS spectrum of Polymer 2, molecules having mass number exhibited in Table 2 were observed; detected were a molecule having mass number having hydrogen-substituted terminal end groups at the both terminal ends, as well as a peak having mass number greater in the extent of phenylene group's formula weight (72) in comparison with the mass number having hydrogen-substituted terminal end group at the both terminal ends, and a molecule having mass number greater in the extent of twice of phenylene group's formula weight phenylene group's formula weight (152) in comparison with the foregoing way. According to this result, Polymer 2 was analyzed as a mixture of the polymer having hydrogen-substituted terminal end groups at the both terminal ends thereof, the polymer having phenyl group at one terminal end thereof and hydrogen-substituted terminal end group at another terminal end thereof, and the polymer having phenyl groups at both terminal ends thereof. In addition, since no peak was observed in the range from 5.5 to 6.0 ppm in high resolution NMR spectrum of Polymer 2, it is found that no unsaturated bond excluding aromatic ring exist at the terminal end of Polymer 2.

TABLE 2
Results of MALDI-TOFMS on Polymer 2

| Mass | | Terminal End |
|---|---|---|
| Number | N | Group |
| 1166.95 | 3 | H-, H- |
| 1242.99 | 3 | H-, Phenyl group |
| 1319.02 | 3 | Phenyl group, |
| | | Phenyl group |
| 1555.27 | 4 | H-, H- |
| 1631.30 | 4 | H-, Phenyl group |
| 1943.58 | 5 | H-, H- |
| 2019.61 | 5 | H-, Phenyl group |
| 2095.64 | 5 | Phenyl group, |
| | | Phenyl group |
| 2331.89 | 6 | H-, H- |
| 2407.92 | 6 | H-, Phenyl group |
| 2720.21 | 7 | H-, H- |
| 2796.24 | 7 | H-, Phenyl group |
| 2872.27 | 7 | Phenyl group, |
| | | Phenyl group |
| 3108.52 | 8 | H-, H- |
| 3184.55 | 8 | H-, Phenyl group |
| 3496.83 | 9 | H-, H- |
| 3572.86 | 9 | H-, Phenyl group |
| 3648.90 | 9 | Phenyl group, |
| | | Phenyl group |
| 3885.15 | 10 | H-, H- |
| 3961.18 | 10 | H-, Phenyl group |
| 4273.46 | 11 | H-, H- |
| 4349.49 | 11 | H-, Phenyl group |
| 4425.52 | 11 | Phenyl group, |
| | | Phenyl group |

Since each atom has some kinds of stable isotopes, a compound is observed in the MALDI-TOFMS spectrum as a set of plural peaks split depending on the presence probability of the stable isotopes. Listed in Table is a typical mass number peak of plural peaks observed in the MALDI-TOFMS spectrum, the typical mass number peak means a peak solely composed of an atom having smallest mass number selected from the stable isotopes thereof, that is, ¹H in hydrogen, ¹²C in carbon atom, ¹⁴N in nitrogen and ¹⁶O in oxygen. A sign of N in Table represents the number of 9,9-diisopentylfluorene repeating unit composing the polymer. A sign of ┌H⁻┘ described in the terminal end group column shows a terminal end group being the foregoing hydrogen-substituted terminal end group, and a sign of ┌Phenyl group┘ shows a terminal end group of molecular chain being phenyl group.

<Resistibility Test to Electrolytic Reduction of Polymer 2>

Since ΔMₚ/Mₚ of Polymer 2 obtained by the foregoing method was a negative value of −0.051, the resistibility to electrolytic reduction of Polymer 2 was low.

A polymer of the invention is resistible to electrolytic oxidation and/or reduction, particularly to electrolytic reduction which seem to be frequently developed by the electric current supplied. A polymer LED employing the polymer is suitably used for curved or flat light sources used for a backlight of liquid crystal display or lighting, segment display, dot matrix flat panel display and the like. A coploymer of the invention is available for dyes for laser, materials for organic solar battery, organic semiconductors of organic transistor and materials for electroconductive thin film.

1. A polymer emitting fluorescence in the solid state, having a polystyrene-reduced weight-average molecular weight of 10³ to 10⁸ and having a repeating unit selected from the group consisting of arylene group, divalent heterocyclic group and divalent aromatic amine group, wherein the polymer has an unsaturated hydrocarbon group free of aromatic ring at least at one terminal end of the main chain thereof with being directly coupled with any of the repeating units.

2. A polymer according to claim 1, wherein the unsaturated hydrocarbon group free of aromatic ring is a group represented by formula (2) and being free of aromatic ring:
CᵢH₂₍ᵢ₋ⱼ₎₋₁— (2)
wherein, i is an integer of 5 or more, and j is an integer satisfying the range of 0≦j<i/2.

3. A polymer according to claim 2, wherein i is 8 and j is any one of 0, 1 or 2 in formula (2).

4. A polymer according to claim 1, wherein the unsaturated hydrocarbon group free of aromatic ring is cyclooctadienyl group.

5. A method for producing the polymer according to claim 4, wherein at least one monomer selected from the group consisting of the following formula (3), (4) and (5) is subjected to reaction with a compound represented by the following formula (6):
Y₁—Ar₁—Y₂ (3);
Y₃—Ar₂—Y₄ (4);
Y₅—Ar₃—Y₆ (5); and
E₁-Y₇ (6);
wherein Ar₁, Ar₂ and Ar₃ each independently represents arylene group, divalent heterocyclic group and divalent aromatic amine group; E₁ represents an unsaturated hydrocarbon group free of aromatic ring; Y₁, Y₂, Y₃, Y₄, Y₅ and Y₆ each independently represents a leaving group; and Y₇ represents a hydrogen atom or a leaving group.

6. A method for producing the polymer according to claim 5, wherein a monomer of which Y₁, Y₂, Y₃, Y₄, Y₅ and Y₆ is each independently a halogen atom, an alkylsulfonyloxy group or an arylsulfonyloxy group, and Y₇ is a hydrogen atom, a halogen atom, an alkylsulfonyloxy group or an arylsulfonyloxy group, is subjected to reaction in the presence of Ni(0) complex.

7. A method for producing the polymer according to claim 5, wherein Y₇ is hydrogen atom and E₁ is a group containing two or more unsaturated bonds.

8. A method for producing the polymer according to claim 7, wherein a compound represented by formula (6) is cyclooctadiene and an amount of the cyclooctadiene is 100 to 300% by mole based on the total amount of monomers represented by formulas (3), (4) and (5).

9. A polymer produced by the method according to claim 5.

10. A polymer composition comprising a polymer having a polystyrene-reduced number-average molecular weight of 10³ to 10⁸ and emitting fluorescence in the solid state, and the polymer according to claim 1.

11. A polymer composition comprising two or more polymers according to claim 1.

12. A polymer light emitting device comprising a light emitting layer disposed between an anode electrode and a cathode electrode, wherein the light emitting layer comprises a polymer emitting fluorescence in the solid state, the polymer having a polystyrene-reduced weight-average molecular weight of 10³ to 10⁸ and having a repeating unit selected from the group consisting of arylene group, divalent heterocyclic group and divalent aromatic amine group, wherein the polymer has an unsaturated hydrocarbon group free of aromatic ring at least at one terminal end of the main chain thereof with being directly coupled with any of the repeating units or a polymer composition comprising a polymer having a polystyrene-reduced number-average molecular weight of 10³ to 10⁸ and emitting fluorescence in the solid state.

13. A flat light source comprising the polymer light emitting device according to claim 12.

14. A segment display comprising the polymer light emitting device according to claim 12.

15. A dot matrix display comprising the polymer light emitting device according to claim 12.

16. A liquid crystal display comprising a backlight composed of the polymer light emitting device according to claim 12.
